SEQUENCE LISTING (21 sequences)

SEQ ID NO: 1 - DNA, 18 bp, synthetic construct
  source 1..18: mol_type = other DNA
acgacgatgcactagaag

SEQ ID NO: 2 - DNA, 19 bp, synthetic construct
  source 1..19: mol_type = other DNA
cgacgatgcactagaagtg

SEQ ID NO: 3 - DNA, 19 bp, synthetic construct
  source 1..19: mol_type = other DNA
accttgagatggtagtacc

SEQ ID NO: 4 - DNA, 19 bp, synthetic construct
  source 1..19: mol_type = other DNA
ctcgctatgctcatcgggt

SEQ ID NO: 5 - DNA, 21 bp, synthetic construct
  source 1..21: mol_type = other DNA
tgtcgctcgctatactcatcg

SEQ ID NO: 6 - DNA, 18 bp, synthetic construct
  source 1..18: mol_type = other DNA
aacaacttcttcttcgcg

SEQ ID NO: 7 - DNA, 19 bp, synthetic construct
  source 1..19: mol_type = other DNA
tgtgacagactgcaagatg

SEQ ID NO: 8 - DNA, 20 bp, synthetic construct
  source 1..20: mol_type = other DNA
cgctgttgagtttaagacgt

SEQ ID NO: 9 - DNA, 21 bp, synthetic construct
  source 1..21: mol_type = other DNA
gatgtcgctgttgggtttaag

SEQ ID NO: 10 - DNA, 18 bp, synthetic construct
  source 1..18: mol_type = other DNA
aacaacttcttcttcgcg

SEQ ID NO: 11 - DNA, 20 bp, synthetic construct
  source 1..20: mol_type = other DNA
ttatgtgtgacagactgcaa

SEQ ID NO: 12 - DNA, 21 bp, synthetic construct
  source 1..21: mol_type = other DNA
gatgtcgctgttgggtttaag

SEQ ID NO: 13 - DNA, 20 bp, synthetic construct
  source 1..20: mol_type = other DNA
cgctgttgagtttaagacgt

SEQ ID NO: 14 - DNA, 18 bp, synthetic construct
  source 1..18: mol_type = other DNA
gacgatgcactagaagtg

SEQ ID NO: 15 - DNA, 19 bp, synthetic construct
  source 1..19: mol_type = other DNA
accttgagatggtagtacc

SEQ ID NO: 16 - DNA, 21 bp, synthetic construct
  source 1..21: mol_type = other DNA
tgctcgctaaactcatcgggt

SEQ ID NO: 17 - DNA, 21 bp, synthetic construct
  source 1..21: mol_type = other DNA
tgtcgctcgctatactcatcg

SEQ ID NO: 18 - DNA, 18 bp, synthetic construct
  source 1..18: mol_type = other DNA
gacgatgcactagaagtg

SEQ ID NO: 19 - DNA, 19 bp, synthetic construct
  source 1..19: mol_type = other DNA
accttgagatggtagtacc

SEQ ID NO: 20 - DNA, 19 bp, synthetic construct
  source 1..19: mol_type = other DNA
ctcgctatgctcatcgggt

SEQ ID NO: 21 - DNA, 21 bp, synthetic construct
  source 1..21: mol_type = other DNA
tgtcgctcgctatactcatcg

(19) United States
(12) Patent Application Publication
(10) Pub. No.: US 2026/0262624 A1
(43) Pub. Date: Sep. 10, 2026

(54) SYSTEMS AND METHODS FOR PEST PRESSURE HEAT MAPS THAT CONVEY INFORMATION RELATING TO GENETIC MARKERS OF RESISTANCE TO PEST CONTROL PRODUCTS

(71) Applicant: FMC CORPORATION, Philadelphia, PA (US)

(72) Inventors: Eduardo DA CRUZ MADURO PICELLI, Paulínia São Paulo (BR); Fabio M. DE ANDRADE SILVA, Paulínia São Paulo (BR); Luis Alfredo Rauer DEMANT, Paulínia São Paulo (BR); Samuel Neves Rodrigues ALVES, Newark, DE (US)

(21) Appl. No.: 19/140,503

(22) PCT Filed: Dec. 14, 2023
(86) PCT No.: PCT/US2023/084015

§ 371 Date: Jun. 18, 2025

Related U.S. Application Data
(60) Provisional application No. 63/433,554, filed on Dec. 19, 2022.

(51) Int. Cl. A01M 1/02; A01M 99/00

(52) U.S. Cl. CPC A01M 1/026; A01M 99/00

(57) ABSTRACT

Systems and methods for generating and displaying heat maps are provided. A heat map generation computing device includes a processor that is programmed to receive trap data for a plurality of pest traps in a geographic location, the trap data including pest genetic data, the trap data including current and historical pest pressure values at each of the plurality of pest traps, receive weather data for the geographic location, receive image data for the geographic location, apply a machine learning algorithm to generate predicted future pest pressure values at each of the plurality of pest traps, generate a first heat map for a first point in time and a second heat map for a second point in time, and transmit the first and second heat maps to a mobile computing device to cause a user interface on the mobile computing device to display a time lapse heat map.

### CROSS-REFERENCE TO RELATED APPLICATIONS

This application claims the benefit of U.S. Provisional Application No. 63/433,554 filed Dec. 19, 2022.

This application claims the benefit of priority to U.S. Provisional Patent Application No. 63/433,554, filed Dec. 19, 2022, the entire contents of which are hereby incorporated by reference herein.

### REFERENCE TO AN ELECTRONIC SEQUENCE LISTING

The contents of the electronic sequence listing (Sequence Listing 38569-751 (61506-WO).xml; Size: 19,668 bytes; and Date of Creation: Nov. 30, 2023) are herein incorporated by reference in their entirety.

### FIELD OF INVENTION

The present application relates generally to a technology that may be used to assist in monitoring pest pressure, and more particularly, to network-based systems and methods for generating and display pest pressure heat maps that convey information relating to genetic markers of resistance or susceptibility to pest control products.

### BACKGROUND

Due to the world's increasing population and decreasing amount of arable land, there is a desire for methods and systems to increase the productivity of agricultural crops. At least one factor that impacts the productivity of agricultural crops is pest pressure. Another factor that impacts the productivity of agricultural crops is the resistance or susceptibility of a pest population to particular pest control product(s). The resistance or susceptibility of a pest population to particular pest control product(s) may be detected by the presence of specific genetic markers for resistance or susceptibility to the particular pest control product(s) within the given pest population.

Accordingly, systems and methods have been developed to monitor and analyze pest pressure. For example, in at least some known systems, a plurality of insect traps are placed in a field of interest. To monitor the pest pressure in the field of interest, the traps are inspected regularly to count the number of pests in each trap. Based on the number of pests in each trap, a pest pressure level for the field of interest can be determined.

The DNA and/or RNA from the pests within the traps may be extracted and analyzed for the presence of a genetic marker for resistance or susceptibility to a pest control product. The DNA and/or RNA from an individual pest may be extracted and analyzed. Alternatively, the DNA and/or RNA extracted from all pests of the same species within a trap may be extracted, combined, and then analyzed for the presence of a genetic marker for resistance or susceptibility to a pest control product.

The number of pests monitored in each trap may also be used to predict future pest pressures. However, pest pressure is a relatively complex phenomenon that is governed by several factors. Thus, accurately predicting future pest pressures based primarily on trap counts may be relatively inaccurate. Further, at least some known systems for pest pressure monitoring are focused at an individual farm level, resulting in limited visualizations and significant time lag in data collections. In addition, at least some known systems for predicting future pest pressure rely on static logic (e.g., fixed phenology models and/or decision trees), and are accordingly limited in their ability to accurately predict future pest pressure.

The pests may be characterized by their ploidy. Generally, the pests may be of any suitable ploidy known in the art. In some embodiments, the pests are haploid (i.e. monoploid), diploid, triploid, tetraploid, pentaploid, hexaploid, heptaploid, septaploid, octoploid, polyploid, or combinations thereof. In some embodiments, the pests are haploid. In some embodiments, the pests are diploid.

Pests that are haploid do not have heterozygosity, such that pesticide resistivity traits may only be characterized as resistant or susceptible. When pests are haploid pests, the pests may be individually characterized as pesticide susceptible and pesticide resistant individuals. Individual characterizations may be applied to a population of individual pests for population-level characterizations. Individual characterizations include monitoring the frequency of resistant alleles and/or susceptible alleles of an individual pest and/or within a pest population. Alternatively, individual characterizations include monitoring the percentage of individuals having susceptible alleles within a pest population.

In contrast, pests that are non-haploid, such as diploid pests, exhibit heterozygosity, such that pesticide resistivity traits may be characterized as pesticide susceptible homozygous, pesticide resistant homozygous, and pesticide resistant heterozygous. When pests are non-haploid pests, the pests may be individually characterized as pesticide susceptible homozygous, pesticide resistant homozygous, and pesticide resistant heterozygous individuals. Individual characterizations may be applied to a population of individual pests for population-level characterizations. Without intending to be limited to any particular theory, the emergence of one, or more than one, of the genetic populations may result in resistance to certain insect control product(s). Consequently, predicting the emergence of one, or more than one, of the genetic populations may assist growers in selecting the appropriate insect control formulations and/or the appropriate time to treat the pest. Likewise, non-insect pests (e.g. fungi, weeds) may also have genetic markers that convey resistance to pesticidal control agents and such genetic populations may be characterized. However, the genetic populations, and their corresponding responses to pesticides, are complex to characterize. It is also complex to ascertain how a particular pest population having a particular genetic population might respond to pesticidal treatment.

The number of pests monitored within each trap that are a pesticide resistant homozygous or pesticide resistant heterozygous may be used to predict future pest pressures that will be resistant to a particular pest control product. Alternatively, the number of pests monitored within each trap that are pesticide susceptible homozygous or pesticide resistant heterozygous may be used to predict future pest pressures that will be susceptible to a particular pest control product.

The number of traps containing pests having a pesticide resistant allele, or that are pesticide resistant homozygous or pesticide resistant heterozygous may be used to predict future pest pressures that will be resistant to a particular pest control product. Alternatively, the number of traps containing pests having a pesticide resistant allele, or that are pesticide susceptible homozygous or pesticide resistant heterozygous may be used to predict future pest pressures that will be susceptible to a particular pest control product.

Accordingly, it would be desirable to provide a system that captures and intelligently analyzes a plurality of different types of information, including pest genetic information, to quickly and accurately predict future pest pressures and/or the likely response of a pest to pesticidal treatment. Further, it would be desirable to present predicted future pest pressures and the genetic profile of the predicted future pest pressure to assist users in performing the technical task of monitoring pest pressure, and optionally optimizing, or selecting a pest treatment system to minimize resistance of a pest to a particular pest control product.

### BRIEF DESCRIPTION

In one aspect, a heat map generation computing device is provided. The heat map generation computing device includes a memory and a processor communicatively coupled to the memory. The processor is programmed to receive trap data for a plurality of pest traps in a geographic location, the trap data including pest genetic data, the trap data including current and historical pest pressure values at each of the plurality of pest traps, receive weather data for the geographic location, receive image data for the geographic location, and apply a machine learning algorithm to the trap data, the weather data, and the image data to generate predicted future pest pressure values at each of the plurality of pest traps. The processor is further programmed to generate a first heat map for a first point in time and a second heat map for a second point in time, the second heat map generated using the predicted future pest pressure values, the first and second heat maps each generated by plotting a plurality of nodes on a map of the geographic location, each node corresponding to one of the plurality of pest traps, each node having a color that represents the pest pressure value for the corresponding pest trap at the associated point in time, and coloring at least some remaining portions of the map of the geographic location to generate a continuous map of pest pressure values for the geographic location by interpolating between pest pressure values associated with the plurality of nodes at the associated point in time. The processor is further programmed to transmit the first and second heat maps to a mobile computing device to cause a user interface on the mobile computing device to display a time lapse heat map that dynamically transitions between the first heat map and the second heat map over time, the user interface implemented via an application installed on the mobile computing device.

In one aspect, the first and second heat map also includes pest pressure corresponding to pesticide susceptible and pesticide resistant populations.

In one aspect, the processor is further programmed to generate a first heat map for a first point in time for pesticide susceptible and pesticide resistant populations and a second heat map for a second point in time, the second heat map generated using the predicted future pesticide susceptible and pesticide resistant populations, the first and second heat maps each generated by plotting a plurality of nodes on a map of the geographic location, each node corresponding to one of the plurality of pest traps, each node having a color that represents the pesticide susceptible and pesticide resistant populations for the corresponding pest trap at the associated point in time, and coloring at least some remaining portions of the map of the geographic location to generate a continuous map of pesticide susceptible and pesticide resistant populations for the geographic location by interpolating between pesticide susceptible and pesticide resistant populations values associated with the plurality of nodes at the associated point in time. The processor is further programmed to transmit the first and second heat maps to a mobile computing device to cause a user interface on the mobile computing device to display a time lapse heat map that dynamically transitions between the first heat map and the second heat map over time, the user interface implemented via an application installed on the mobile computing device.

In another aspect, method for generating heat maps is provided. The method is implemented using a heat map generation computing device including a memory communicatively coupled to a processor. The method includes receiving trap data for a plurality of pest traps in a geographic location, the trap data including pest genetic data, the trap data including current and historical pest pressure values at each of the plurality of pest traps, receiving weather data for the geographic location, receiving image data for the geographic location, and applying a machine learning algorithm to the trap data, the weather data, and the image data to generate predicted future pest pressure values at each of the plurality of pest traps. The method further includes generating a first heat map for a first point in time and a second heat map for a second point in time, the second heat map generated using the predicted future pest pressure values, the first and second heat maps each generated by plotting a plurality of nodes on a map of the geographic location, each node corresponding to one of the plurality of pest traps, each node having a color that represents the pest pressure value for the corresponding pest trap at the associated point in time, and coloring at least some remaining portions of the map of the geographic location to generate a continuous map of pest pressure values for the geographic location by interpolating between pest pressure values associated with the plurality of nodes at the associated point in time. The method further includes transmitting the first and second heat maps to a mobile computing device to cause a user interface on the mobile computing device to display a time lapse heat map that dynamically transitions between the first heat map and the second heat map over time, the user interface implemented via an application installed on the mobile computing device.

In another aspect, a method for generating heat maps is provided. The method is implemented using a heat map generation computing device including a memory communicatively coupled to a processor. The method includes receiving trap data for a plurality of pest traps in a geographic location, the trap data including pest genetic data, the trap data including current and historical pest pressure values at each of the plurality of pest traps, receiving weather data for the geographic location, receiving image data for the geographic location, and applying a machine learning algorithm to the trap data, the weather data, and the image data to generate predicted future pest pressure values at each of the plurality of pest traps. The method further includes generating a first heat map for a first point in time for pesticide susceptible and pesticide resistant populations and a second heat map for a second point in time for pesticide susceptible and pesticide resistant populations, the second heat map generated using the predicted future pest pressure values for pesticide susceptible and pesticide resistant populations, the first and second heat maps each generated by plotting a plurality of nodes on a map of the geographic location, each node corresponding to one of the plurality of pest traps, each node having a color that represents the pest pressure value for pesticide susceptible and pesticide resistant populations for the corresponding pest trap at the associated point in time, and coloring at least some remaining portions of the map of the geographic location to generate a continuous map of pest pressure values for pesticide susceptible and pesticide resistant populations for the geographic location by interpolating between pest pressure values associated with the plurality of nodes at the associated point in time. The method further includes transmitting the first and second heat maps to a mobile computing device to cause a user interface on the mobile computing device to display a time lapse heat map that dynamically transitions between the first heat map and the second heat map over time, the user interface implemented via an application installed on the mobile computing device.

In yet another aspect, a computer-readable storage medium having computer-executable instructions embodied thereon is provided. When executed by a heat map generation computing device including at least one processor in communication with a memory, the computer-readable instructions cause the heat map generation computing device to receive trap data for a plurality of pest traps in a geographic location, the trap data including pest genetic data, the trap data including current and historical pest pressure values at each of the plurality of pest traps, receive weather data for the geographic location, receive image data for the geographic location, and apply a machine learning algorithm to the trap data, the genetic data, the weather data, and the image data to generate predicted future pest pressure values for pesticide susceptible and pesticide resistant populations at each of the plurality of pest traps. The instructions further cause the heat map generation computing device to generate a first heat map for a first point in time for pesticide susceptible and pesticide resistant populations and a second heat map for a second point in time for pesticide susceptible and pesticide resistant populations, the second heat map generated using the predicted future pest pressure values for pesticide susceptible and pesticide resistant populations, the first and second heat maps each generated by plotting a plurality of nodes on a map of the geographic location, each node corresponding to one of the plurality of pest traps, each node having a color that represents the pest pressure value for the corresponding pest trap at the associated point in time for pesticide susceptible and pesticide resistant populations, and coloring at least some remaining portions of the map of the geographic location to generate a continuous map of pest pressure values for the geographic location by interpolating between pest pressure values associated with the plurality of nodes at the associated point in time for pesticide susceptible and pesticide resistant populations. The instructions further cause the heat map generation computing device to transmit the first and second heat maps to a mobile computing device to cause a user interface on the mobile computing device to display a time lapse heat map that dynamically transitions between the first heat map and the second heat map over time, the user interface implemented via an application installed on the mobile computing device.

### BRIEF DESCRIPTION OF THE DRAWINGS

FIG. 1 is a block diagram of a computer system used in predicting pest pressures in accordance with the present disclosure.

FIG. 2 is a block diagram illustrating data flow through the system shown in FIG. 1 in accordance with the present disclosure.

FIG. 3 illustrates an example configuration of a server system such as the pest pressure prediction computing device of FIGS. 1 and 2 in accordance with the present disclosure.

FIG. 4 illustrates an example configuration of a client system shown in FIGS. 1 and 2 in accordance with the present disclosure.

FIG. 5 is a flow diagram of an example method for generating pest pressure data using the system shown in FIG. 1 in accordance with the present disclosure.

FIG. 6 is a flow diagram of an example method for generating heat maps using the system shown in FIG. 1 in accordance with the present disclosure.

FIG. 7 is a screenshot of a user interface that may be generated using the system shown in FIG. 1 in accordance with the present disclosure.

FIG. 8 is a screenshot of a user interface that may be generated using the system shown in FIG. 1 in accordance with the present disclosure.

FIG. 9 is a screenshot of a user interface that may be generated using the system shown in FIG. 1 in accordance with the present disclosure.

FIG. 10 is a screenshot of a user interface that may be generated using the system shown in FIG. 1 in accordance with the present disclosure.

FIG. 11 is an expected result of an allelic discrimination plot in accordance with the present disclosure.

FIG. 12 is an expected result of an allelic discrimination plot in accordance with the present disclosure.

FIG. 13 is a graph depicting the R allele frequency vs bioassay at LC99 for certain genetic populations in accordance with the present disclosure.

FIG. 14 is a graph depicting the R allele frequency vs mortality at LC99 for certain genetic populations in accordance with the present disclosure.

FIG. 15 is a graph depicting the mortality at LC99 observed in certain genetic populations following treatment with the indicated diamide-containing insect control formulations in accordance with the present disclosure.

FIG. 16 is a graph depicting relative resistance levels to various pesticides for certain genetic populations having certain mutations in accordance with the present disclosure.

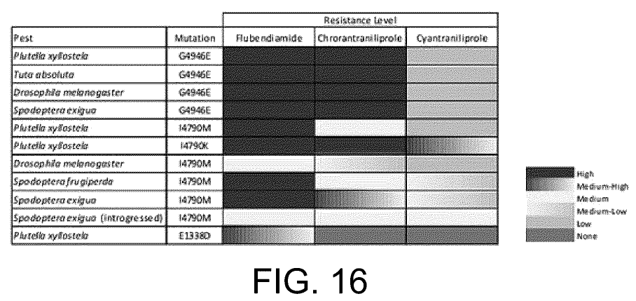

FIG. 17 is an illustrative treatment window recommendation in accordance with the present disclosure.

FIG. 18 is an illustrative treatment window recommendation in accordance with the present disclosure.

FIG. 19 is an allelic discrimination plot in accordance with the present disclosure.

FIG. 20 is an allelic discrimination plot in accordance with the present disclosure.

FIG. 21 is an allelic discrimination plot in accordance with the present disclosure.

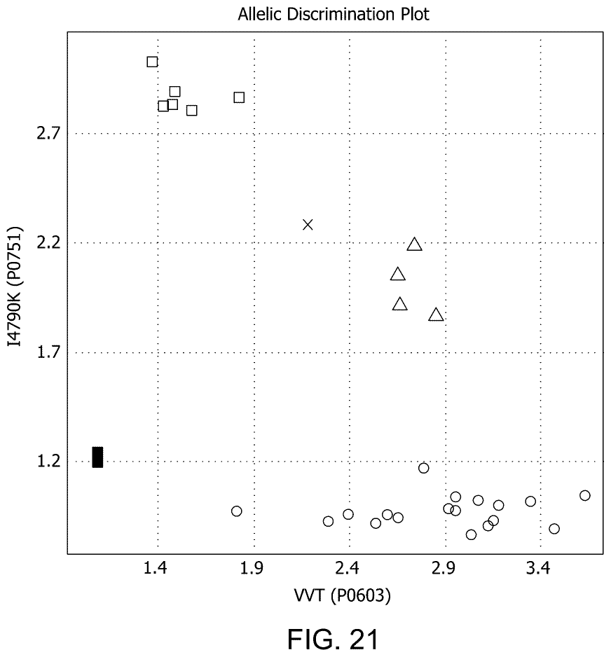

Although specific features of various embodiments may be shown in some drawings and not in others, this is for convenience only. Any feature of any drawing may be referenced and/or claimed in combination with any feature of any other drawing.

### DETAILED DESCRIPTION

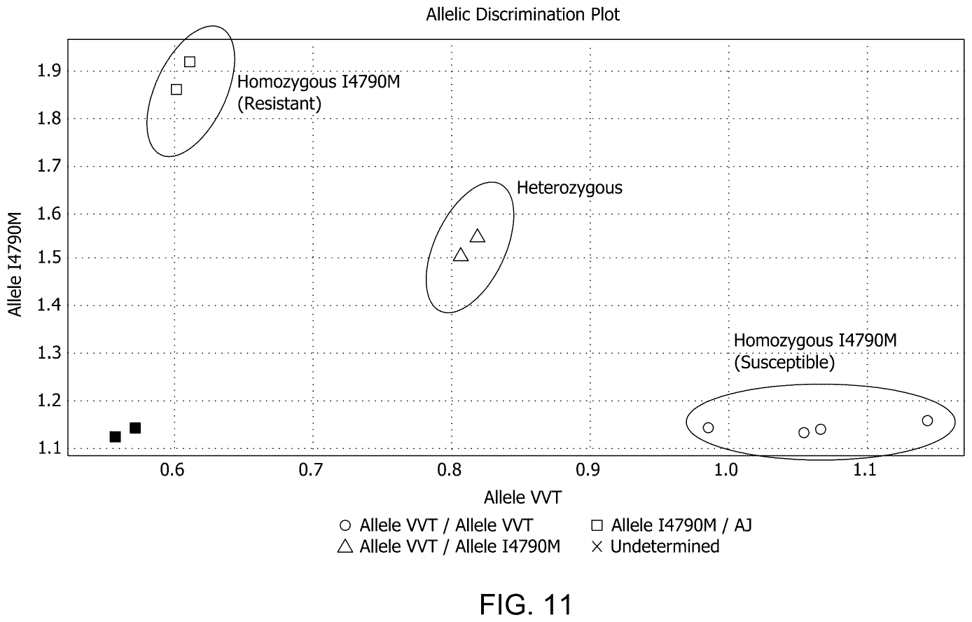

The systems and methods described herein are directed to computer-implemented systems for generating and displaying pest pressure heat maps for pesticide susceptible and pesticide resistant populations. A heat map generation computing device receives trap data for a plurality of pest traps in a geographic location, the trap data including pest genetic data, receives weather data for the geographic location, receives image data for the geographic location, and applies a machine learning algorithm to the trap data, the weather data, and the image data to generate predicted future pest pressure values for pesticide susceptible and pesticide resistant populations at each of the plurality of pest traps. The heat map generation computing device generates a first heat map for a first point in time for pesticide susceptible and pesticide resistant populations and a second heat map for a second point in time for pesticide susceptible and pesticide resistant populations, the second heat map generated using the predicted future pest pressure values for pesticide susceptible and pesticide resistant populations, the first and second heat maps each generated by plotting a plurality of nodes on a map of the geographic location, each node corresponding to one of the plurality of pest traps, each node having a color that represents the pest pressure value for the corresponding pest trap at the associated point in time for pesticide susceptible and pesticide resistant populations, and coloring at least some remaining portions of the map of the geographic location to generate a continuous map of pest pressure values for pesticide susceptible and pesticide resistant populations for the geographic location by interpolating between pest pressure values associated with the plurality of nodes at the associated point in time for pesticide susceptible and pesticide resistant populations. The first and/or heat maps may also include information comprising the genetic marker populations (e.g. pesticide susceptible homozygous, pesticide resistant homozygous, or pesticide resistant heterozygous as shown in FIG. 11). The heat map generation computing device transmits the first and second heat maps to a mobile computing device to cause a user interface on the mobile computing device to display a time lapse heat map that dynamically transitions between the first heat map and the second heat map over time, the user interface implemented via an application installed on the mobile computing device.

The systems and methods described herein facilitate accurately predicting pest pressure for pesticide susceptible and pesticide resistant populations at one or more geographic locations. As used herein, a ‘geographic location’ generally refers to an agriculturally relevant geographic location (e.g., a location including one or more fields and/or farms for producing crops). Further, as used here, ‘pest pressure’ refers to a qualitative and/or quantitative assessment of the abundance of pests present at a particular location for pesticide susceptible and pesticide resistant populations. For example, a high pest pressure indicates that a relatively large abundance (e.g., as compared to an expected abundance) of pests are present at the location. In contrast, a low pest pressure indicates that a relatively low abundance of pests are present at the location. In at least some of the embodiments described herein, pest pressure is analyzed for agricultural purposes. That is, pest pressure is monitored and predicted for one or more fields. However, those of skill in the art will appreciate that the systems and methods described herein may be used to analyze pest pressure in any suitable environment.

In some embodiments, the pests are non-haploid. In some embodiments, the pests are diploid. In some embodiments, the pests are haploid.

As used herein, the term ‘pest’ refers to an organism whose presence is generally undesirable at the particular geographic location, in particular an agriculturally relevant geographic location. For example, for implementations that analyze pest pressure for one or more fields, pests may include insects that have a propensity to damage crops in those fields. However, those of skill in the art will appreciate that the systems and methods described herein may be used to analyze pest pressure for other types of pests. For example, in some embodiments, pest pressure may be analyzed for fungi, weeds, and/or diseases. The systems and methods described herein refer to ‘pest traps’ and ‘trap data’. As used herein, ‘pest traps’ may refer to any device capable of containing and/or monitoring presence of a pest of interest, and ‘trap data’ may refer to data gathered using such a device. For example, for insects, the ‘pest trap’ may be a conventional containment device that secures the pest. Alternatively, for fungi, weeds, or diseases, the ‘pest trap’ may refer to any device capable of monitoring presence and/or levels of the fungi, weeds, and/or diseases. For example, in embodiments where the ‘pest’ is one or more species of fungi, the ‘pest trap’ may refer to a sensing device capable of quantitatively measuring a level of spores associated with the one or more species of fungi in the ambient environment around the sensing device. In one embodiment, the ‘pest’ is a type of insect or multiple types of insects, and the terms ‘pest trap’ and ‘pest traps’ refer to ‘insect trap’ and ‘insect traps’, respectively.

In some embodiments, when the pests are haploid pests, monitoring pest pressure comprises monitoring the change in frequency of resistant alleles and/or susceptible alleles of an individual pest and/or within a pest population.

In some embodiments, the change in frequency of the resistant alleles is less than about 1%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100%.

In some embodiments, the change in frequency of the susceptible alleles is less than about 1%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100%.

In some embodiments, when the pests are haploid pests, monitoring pest pressure comprises comparing the frequency of resistant alleles and/or susceptible alleles of an individual pest and/or within a pest population taken at a first time to the frequency of resistant alleles and/or susceptible alleles of an individual pest and/or within a pest population taken at a second time. In these embodiments, a threshold value of change may be used to determine significance. For example, a change in resistance frequency of 10% may be used as a threshold.

In some embodiments, when the pests are non-haploid pests, the pests may be individually characterized as pesticide susceptible homozygous, pesticide resistant homozygous, and pesticide resistant heterozygous individuals. Individual characterizations may be applied to a population of individual pests for population-level characterizations.

In some embodiments, when the pests are polyploid pests, the pests may be individually characterized as pesticide susceptible homozygous, pesticide resistant homozygous, and pesticide resistant heterozygous individuals. Pesticide resistant heterozygous individuals may differ from each other and possess varying degrees of pesticide resistance depending on their genetic differences. Individual characterizations may be applied to a population of individual pests for population-level characterizations.

The following detailed description of the embodiments of the disclosure refers to the accompanying drawings. The same reference numbers in different drawings may identify the same or similar elements. Also, the following detailed description does not limit the claims.

Described herein are computer systems such as pest pressure prediction computing devices. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to predicting pest pressure.

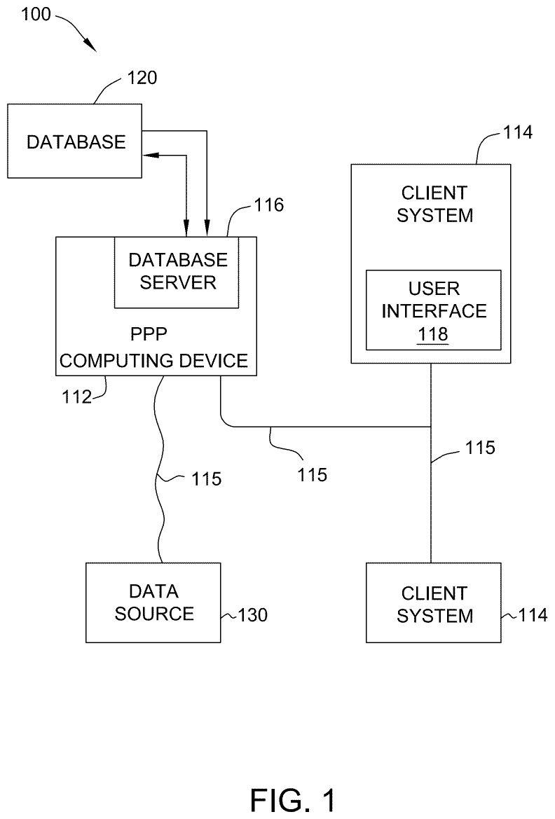

FIG. 1 is a block diagram of an example embodiment of a computer system 100 used in predicting pest pressures that includes a pest pressure prediction (PPP) computing device 112 in accordance with one example embodiment of the present disclosure. PPP computing device 112 may also be referred to herein as a heat map generation computing device, as described herein. In the example embodiment, system 100 is used for predicting pest pressures and generating pest pressure heat maps, as described herein.

More specifically, in the example embodiment, system 100 includes pest pressure prediction (PPP) computing device 112, and a plurality of client sub-systems, also referred to as client systems 114, connected to PPP computing device 112. In one embodiment, client systems 114 are computers including a web browser, such that PPP computing device 112 is accessible to client systems 114 using the Internet and/or using network 115. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with farmers, growers, scouts, etc. as well as external systems used to store data. PPP computing device 112 is also in communication with one or more data sources 130 using network 115. Further, client systems 114 may additionally communicate with data sources 130 using network 115. Further, in some embodiments, one or more client systems 114 may serve as data sources 130, as described herein. Client systems 114 may be any device capable of interconnecting to the Internet including a web-based phone, PDA, or other web-based connectable equipment.

A database server 116 is connected to a database 120, which contains information on a variety of matters, as described below in greater detail. In one embodiment, centralized database 120 is stored on PPP device 112 and can be accessed by potential users at one of client systems 114 by logging onto PPP computing device 112 through one of client systems 114. In an alternative embodiment, database 120 is stored remotely from PPP device 112 and may be non-centralized. Database 120 may be a database configured to store information used by PPP computing device 112 including, for example, transaction records, as described herein.

Database 120 may include a single database having separated sections or partitions, or may include multiple databases, each being separate from each other. Database 120 may store data received from data sources 130 and generated by PPP computing device 112. For example, database 120 may store weather data, imaging data, trap data, scouting data, grower data, pest pressure prediction data, and/or heat map data, as described in detail herein.

In the example embodiment, client systems 114 may be associated with, for example, a grower, a scouting entity, a pest management entity, and/or any other party capable of using system 100 as described herein. In the example embodiment, at least one of client systems 114 includes a user interface 118. For example, user interface 118 may include a graphical user interface with interactive functionality, such that pest pressure predictions and/or heat maps, transmitted from PPP computing device 112 to client system 114, may be shown in a graphical format. A user of client system 114 may interact with user interface 118 to view, explore, and otherwise interact with the displayed information.

In the example embodiment, PPP computing device 112 receives data from a plurality of data sources 130, and aggregates and analyzes the received data (e.g., using machine learning) to generate pest pressure predictions and/or heat maps, as described in detail herein.

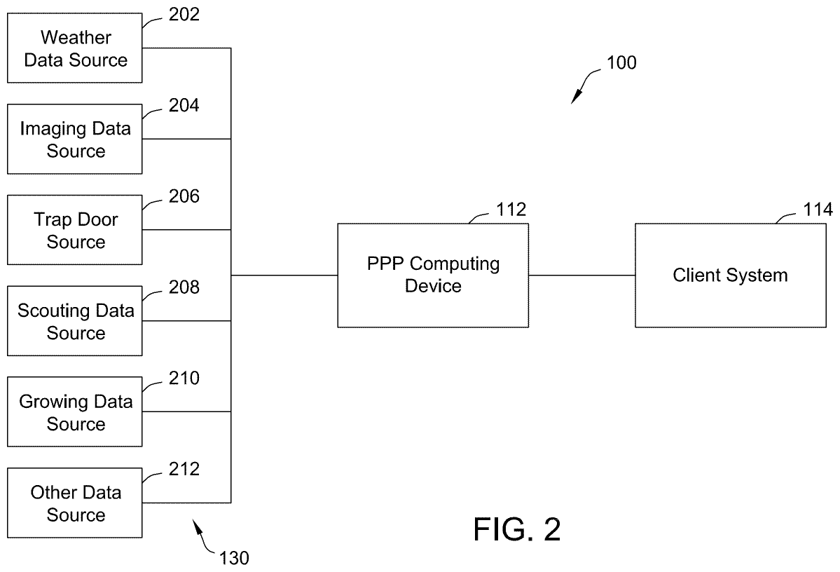

FIG. 2 is a block diagram illustrating data flow through system 100. In the embodiment shown in FIG. 2, data sources 130 include a weather data source 202, an imaging data source 204, a trap data source 206, a scouting data source, a grower data source 210, and an another data source 212. Those of skill in the art will appreciate that data sources 130 shown in FIG. 2 are merely examples, and that system 100 may include any suitable number and type of data source.

Weather data source 202 provides weather data to PPP computing device 112 for use in generating pest pressure predictions. Weather data may include, for example, temperature data (e.g., indicating current and/or past temperatures measured at one or more geographic locations), humidity data (e.g., indicating current and/or past humidity at measured at one or more geographic locations), wind data (e.g., indicating current and/or past wind levels and direction measured at one or more geographic locations), rainfall data (e.g., indicating current and/or past rainfall levels measured at one or more geographic locations), and forecast data (e.g., indicating future weather conditions predicted for one or more geographic locations).

Imaging data source 204 provides image data to PPP computing device 112 for use in generating pest pressure predictions. Image data may include, for example, satellite images and/or drone images acquired of one or more geographic locations.

Trap data source 206 provides trap data to PPP computing device 112 for use in generating pest pressure predictions. Trap data may include, for example, pest counts (e.g., expressed as number of a pest species, density of the pest species, or the like) from at least one pest trap in a geographic location. Further, trap data may include, for example, in the case of insects, pest type (e.g., taxonomic genus, species, variety, etc.) and/or pest developmental stage and gender (e.g., larva, juvenile, adult, male, female, etc.). The pest traps may be, for example, insect traps. Alternatively, the pest traps may be any device capable of determining a pest presence and providing trap data to PPP computing device 112 as described herein. For example, in some embodiments, the pest traps are sensing devices operable to sense an ambient level of spores associated with one or more species of fungi. In such embodiments, the trap data may include, for example, number of spores (representing the pest count), fungus type, fungus developmental stage, etc.

In some embodiments, trap data source 206 is a pest trap that is communicatively coupled to PPP computing device 112 (e.g., over a wireless communication link). Accordingly, in such embodiments, trap data source 206 may be capable of automatically determining a pest count in the pest trap (e.g., using image processing algorithms) and transmitting the determined pest count to PPP computing device.

In many embodiments, the trap data include pest genetic data. In one embodiment, pest genetic data are particularly beneficial in order to analyze one or more markers of pesticidal resistance in a population. Such markers of pesticidal resistance may be monitored through pre-emergence, emergence, and/or post-emergence.

In one embodiment, population dynamics may be integrated with pest genetic data (e.g. R allele detection). In this embodiment, mapping may result in precise treatment recommendations.

Generally, the genetic data may be collected according to any suitable method known in the art. For example, by way of illustration, collecting genetic data may comprise manually collecting genetic data and/or automatically collecting genetic data. In some examples, collecting genetic data may comprise collecting genetic data selected from phenotypes, genotypes, epigenotypes, allelic distributions, and combinations thereof. In some examples, genetic data may be collected with a technique selected from polymerase chain reaction (PCR), quantitative polymerase chain reaction (qPCR), real time reverse transcription polymerase chain reaction (RT-PCR), loop-mediated isothermal amplification (LAMP), and combinations thereof.

Generally, the genetic data may comprise any suitable genetic marker known in the art. In some embodiments, the genetic data comprise a genetic marker selected from single nucleotide polymorphisms, and combinations thereof.

In some embodiments, the genetic data inform a treatment recommendation. In many embodiments, the treatment recommendation comprises a composition for treating a pest population.

As used herein, the compositions according to the present disclosure are compositions applied to a pest population and/or recommended by a treatment program.

In many embodiments, the treatment recommendation recommends a composition comprising at least one active ingredient. In some embodiments, the treatment recommendation recommends a composition comprising at least two active ingredients. In some embodiments, the treatment recommendation recommends a composition comprising at least two active ingredients, wherein the active ingredients have at least one different mode of action (MoA).

In many embodiments, the treatment recommendation recommends applying one or more compositions in one or more treatment windows. In some embodiments, the one or more compositions of the one or more treatment windows comprise active ingredients having at least one different mode of action.

In many embodiments, the active ingredient is selected from the group consisting of insecticides, herbicides, biopesticides, nematicides, bactericides, and fungicides. General references for these active ingredients (i.e. insecticides, fungicides, nematocides, acaricides, herbicides and biological agents) include The Pesticide Manual, 13th Edition, C. D. S. Tomlin, Ed., British Crop Protection Council, Farnham, Surrey, U. K., 2003 and The BioPesticide Manual, 2^{nd} Edition, L. G. Copping, Ed., British Crop Protection Council, Farnham, Surrey, U.K., 2001.

Non-limiting examples of insecticides include abamectin, acephate, acequinocyl, acetamiprid, acrinathrin, acynonapyr, afidopyropen ([(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11H-naphtho[2,1-b]pyrano[3,4-e]pyran-4-yl]methyl cyclopropanecarboxylate), amidoflumet, amitraz, avermectin, azadirachtin, azinphos-methyl, benfuracarb, bensultap, benzpyrimoxan, bifenthrin, kappa-bifenthrin, bifenazate, bistrifluron, borate, broflanilide, buprofezin, cadusafos, carbaryl, carbofuran, cartap, carzol, chlorfenapyr, chlorfluazuron, chloroprallethrin, chlorpyrifos, chlorpyrifos-e, chlorpyrifos-methyl, chromafenozide, clofentezin, chloroprallethrin, clothianidin, cycloprothrin, cycloxaprid ((5S,8R)-1[(6-chloro-3-pyridinyl)methyl]-2,3,5,6,7,8-hexahydro-9-nitro-5,8-Epoxy-1H-imidazo[1,2 -a]azepine), cyenopyrafen, cyflumetofen, cyfluthrin, beta-cyfluthrin, cyhalothrin, gamma-cyhalothrin, lambda-cyhalothrin, cypermethrin, alpha-cypermethrin, zeta-cypermethrin, cyromazine, deltamethrin, diafenthiuron, diazinon, dicloromesotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(trifluoromethoxy)phenoxy]-4-quinolinyl methyl carbonate), flonicamid, fluazaindolizine, flucythrinate, flufenerim, flufenoxuron, flufenoxystrobin (methyl (αE)-2-[[2-chloro-4-(trifluoromethyl)phenoxy]methyl]-α-(methoxymethylene)benzeneacetate), fluensulfone (5-chloro-2-[(3,4,4-trifluoro-3-buten-1-yl)sulfonyl]thiazole), fluhexafon, fluopyram, flupiprole (1-[2,6-dichloro-4-(trifluoromethyl)phenyl]-5-[(2-methyl-2-propen-1-yl)amino]-4-[(trifluoromethyl)sulfinyl]-1H-pyrazole-3-carbonitrile), flupyradifurone (4-[[(6-chloro-3-pyridinyl)methyl](2,2-difluoroethyl)amino]-2(5H)-furanone), flupyrimin, fluvalinate, tau-fluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin ([2,3,5,6-tetrafluoro-4-(methoxymethyl)phenyl]methyl (1R,3S)-3-(2,2-dichloroethenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethylcyclopropanecarboxylate), nicotine, nitenpyram, nithiazine, novaluron, noviflumuron, N-[1,1-dimethyl-2-(methylthio)ethyl]-7-fluoro-2-(3-pyridinyl)-2H-indazole-4-carboxamide, N-[1,1-dimethyl-2-(methylsulfinyl)ethyl]-7-fluoro-2-(3-pyridinyl)-2H-indazole-4-carboxamide, N-[1,1-dimethyl-2-(methylsulfonyl)ethyl]-7-fluoro-2-(3-pyridinyl)-2H-indazole-4-carboxamide, N-(1-methylcyclopropyl)-2-(3-pyridinyl)-2H-indazole-4-carboxamide, N-[1 -(difluoromethyl)cyclopropyl]-2-(3-pyridinyl)-2H-indazole-4-carboxamide, oxamyl, oxazosulfyl, parathion, parathion-methyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin, pyridaben, pyridalyl, pyrifluquinazon, pyriminostrobin (methyl (αE)-2-[[[2-[(2,4-dichlorophenyl)amino]-6-(trifluoromethyl)-4-pyrimidinyl]oxy]methyl]-α-(methoxymethylene)benzeneacetate), pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-λ⁴-sulfanylidene]cyanamide), tebufenozide, tebufenpyrad, teflubenzuron, tefluthrin, kappa-tefluthrin, terbufos, tetrachlorvinphos, tetramethrin, tetramethylfluthrin ([2,3,5,6-tetrafluoro-4-(methoxymethyl)phenyl]methyl 2,2,3,3-tetramethylcyclopropanecarboxylate), thiacloprid, thiamethoxam, thiodicarb, thiosultap-sodium, tioxazafen (3-phenyl-5-(2-thienyl)-1,2,4-oxadiazole), tolfenpyrad, tralomethrin, triazamate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuron, tyclopyrazoflor, zeta-cypermethrin, Bacillus thuringiensis delta-endotoxins, entomopathogenic bacteria, entomopathogenic viruses or entomopathogenic fungi, can combinations thereof.

Non-limiting examples of insecticides also include diamides, such as chlorantraniliprole, cyantraniliprole, tetrachlorantraniliprole, bromoantraniliprole, dichlorantraniliprole, tetraniliprole, cyclaniliprole, cyhalodiamide, and flubendiamide.

Non-limiting examples of fungicides include fungicides such as acibenzolar-S-methyl, aldimorph, ametoctradin, aminopyrifen, amisulbrom, anilazine, azaconazole, azoxystrobin, benalaxyl (including benalaxyl-M), benodanil, benomyl, benthiavalicarb (including benthiavalicarb-isopropyl), benzovindiflupyr, bethoxazin, binapacryl, biphenyl, bitertanol, bixafen, blasticidin-S, boscalid, bromuconazole, bupirimate, buthiobate, carboxin, carpropamid, captafol, captan, carbendazim, chloroneb, chlorothalonil, chlozolinate, copper hydroxide, copper oxychloride, copper sulfate, coumoxystrobin, cyazofamid, cyflufenamid, cymoxanil, cyproconazole, cyprodinil, dichlobentiazox, dichlofluanid, diclocymet, diclomezine, dicloran, diethofencarb, difenoconazole, diflumetorim, dimethirimol, dimethomorph, dimoxystrobin, diniconazole (including diniconazole-M), dinocap, dipymetitrone, dithianon, dithiolanes, dodemorph, dodine, econazole, etaconazole, edifenphos, enoxastrobin (also known as enestroburin), epoxiconazole, ethaboxam, ethirimol, etridiazole, famoxadone, fenamidone, fenaminstrobin, fenarimol, fenbuconazole, fenfuram, fenhexamide, fenoxanil, fenpiclonil, fenpicoxamid, fenpropidin, fenpropimorph, fenpyrazamine, fentin acetate, fentin hydroxide, ferbam, ferimzone, flometoquin, florylpicoxamid, fluopimomide, fluazinam, fludioxonil, flufenoxystrobin, fluindapyr, flumorph, fluopicolide, fluopyram, fluoxapiprolin, fluoxastrobin, fluquinconazole, flusilazole, flusulfamide, flutianil, flutolanil, flutriafol, fluxapyroxad, folpet, fthalide (also known as phthalide), fuberidazole, furalaxyl, furametpyr, hexaconazole, hymexazole, guazatine, imazalil, imibenconazole, iminoctadine albesilate, iminoctadine triacetate, inpyrfluxam, iodicarb, ipconazole, ipfentrifluconazole, ipflufenoquin, isofetamid, iprobenfos, iprodione, iprovalicarb, isoflucypram, isoprothiolane, isopyrazam, isotianil, kasugamycin, kresoxim-methyl, lancotrione, mancozeb, mandipropamid, mandestrobin, maneb, mapanipyrin, mefentrifluconazole, mepronil, meptyldinocap, metalaxyl (including metalaxyl-M/mefenoxam), metconazole, methasulfocarb, metiram, metominostrobin, metyltetraprole, metrafenone, myclobutanil, naftitine, neo-asozin (ferric methanearsonate), nuarimol, octhilinone, ofurace, orysastrobin, oxadixyl, oxathiapiprolin, oxolinic acid, oxpoconazole, oxycarboxin, oxytetracycline, penconazole, pencycuron, penflufen, penthiopyrad, perfurazoate, phosphorous acid (including salts thereof, e.g., fosetyl-aluminm), picoxystrobin, piperalin, polyoxin, probenazole, prochloraz, procymidone, propamocarb, propiconazole, propineb, proquinazid, prothiocarb, prothioconazole, pydiflumetofen (Adepidyn®), pyraclostrobin, pyrametostrobin, pyrapropoyne, pyraoxystrobin, pyraziflumid, pyrazophos, pyribencarb, pyributacarb, pyridachlometyl, pyrifenox, pyriofenone, perisoxazole, pyrimethanil, pyrifenox, pyrrolnitrin, pyroquilon, quinconazole, quinmethionate, quinofumelin, quinoxyfen, quintozene, silthiofam, sedaxane, simeconazole, spiroxamine, streptomycin, sulfur, tebuconazole, tebufloquin, teclofthalam, tecloftalam, teenazene, terbinafine, tetraconazole, thiabendazole, thifluzamide, thiophanate, thiophanate-methyl, thiram, tiadinil, tolclofos-methyl, tolprocarb, tolyfluanid, triadimefon, triadimenol, triarimol, triazoxide, tribasic copper sulfate, triclopyricarb, tridemorph, trifloxystrobin, triflumizole, trimoprhamide tricyclazole, trifloxystrobin, triforine, triticonazole, uniconazole, validamycin, valifenalate (also known as valifenal), vinclozolin, zineb, ziram, zoxamide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, and combinations thereof.

Non-limiting examples of nematicides include fluopyram, spirotetramat, thiodicarb, fosthiazate, abamectin, iprodione, fluensulfone, dimethyl disulfide, tioxazafen, 1,3-dichloropropene (1,3-D), metam (sodium and potassium), dazomet, chloropicrin, fenamiphos, ethoprophos, cadusaphos, terbufos, imicyafos, oxamyl, carbofuran, tioxazafen, Bacillus firmus, Pasteuria nishizawae, and combinations thereof. A non-limiting example of a bactericide is streptomycin. Non-limiting examples of acaricides include amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad, and combinations thereof.

Non-limiting examples of herbicides include acetochlor, acifluorfen and its sodium salt, aclonifen, acrolein (2-propenal), alachlor, alloxydim, ametryn, amicarbazone, amidosulfuron, aminocyclopyrachlor and its esters (e.g., methyl, ethyl) and salts (e.g., sodium, potassium), aminopyralid, amitrole, ammonium sulfamate, anilofos, asulam, atrazine, azimsulfuron, bixlozone, beflubutamid, beflubutamid-M, benazolin, benazolin-ethyl, bencarbazone, benfluralin, benfuresate, benquinotrione, bensulfuron-methyl, bensulide, bentazone, benzobicyclon, benzofenap, bicyclopyrone, bifenox, bilanafos, bipyrazone, bispyribac and its sodium salt, bromacil, bromobutide, bromofenoxim, bromoxynil, bromoxynil octanoate, butachlor, butafenacil, butamifos, butralin, butroxydim, butylate, cafenstrole, carbetamide, carfentrazone-ethyl, catechin, chlomethoxyfen, chloramben, chlorbromuron, chlorflurenol-methyl, chloridazon, chlorimuron-ethyl, chlorotoluron, chlorpropham, chlorsulfuron, chlorthal-dimethyl, chlorthiamid, cinidon-ethyl, cinmethylin, cinosulfuron, clacyfos, clefoxydim, clethodim, clodinafop-propargyl, clomazone, clomeprop, clopyralid, clopyralid-olamine, cloransulam-methyl, cumyluron, cyanazine, cycloate, cyclopyranil, cyclopyrimorate, cyclosulfamuron, cycloxydim, cyhalofop-butyl, cypyrafluone, 2,4-D and its butotyl, butyl, isoctyl and isopropyl esters and its dimethylammonium, diolamine and trolamine salts, daimuron, dalapon, dalapon-sodium, dazomet, 2,4-DB and its dimethylammonium, potassium and sodium salts, desmedipham, desmetryn, dicamba and its diglycolammonium, dimethylammonium, potassium and sodium salts, dichlobenil, dichlorprop, diclofop-methyl, diclosulam, difenzoquat metilsulfate, diflufenican, diflufenzopyr, dimefuron, dimesulfazet, dimepiperate, dimesulfazet, dimethachlor, dimethametryn, dimethenamid, dimethenamid-P, dimethipin, dimethylarsinic acid and its sodium salt, dinitramine, dinoterb, dioxopyritrione, diphenamid, diquat dibromide, dithiopyr, diuron, DNOC, endothal, EPTC, epyrifenacil, esprocarb, ethalfluralin, ethametsulfuron-methyl, ethiozin, ethofumesate, ethoxyfen, ethoxysulfuron, etobenzanid, fenoxaprop-ethyl, fenoxaprop-P-ethyl, fenoxasulfone, fenpyrazone, fenquinotrione, fentrazamide, fenuron, fenuron-TCA, flamprop-methyl, flamprop-M-isopropyl, flamprop-M-methyl, flazasulfuron, florasulam, fluazifop-butyl, fluazifop-P-butyl, fluazolate, flucarbazone, flucetosulfuron, fluchloralin, fluchloraminopyr, flufenacet, flufenoximacil, flufenpyr, flufenpyr-ethyl, flumetsulam, flumiclorac-pentyl, flumioxazin, fluometuron, fluoroglycofen-ethyl, flupoxam, flupyrsulfuron-methyl and its sodium salt, flurenol, flurenol-butyl, fluridone, flurochloridone, fluroxypyr, flurtamone, flusulfinam, fluthiacet-methyl, fomesafen, foramsulfuron, fosamine-ammonium, glufosinate, glufosinate-ammonium, L-glufosinate-ammonium, glufosinate-P, glyphosate and its salts such as ammonium, isopropylammonium, potassium, sodium (including sesquisodium) and trimesium (alternatively named sulfosate), halauxifen, halauxifen-methyl, halosulfuron-methyl, haloxyfop-etotyl, haloxyfop-methyl, hexazinone, hydantocidin, imazamethabenz-methyl, imazamox, imazapic, imazapyr, imazaquin, imazaquin-ammonium, imazethapyr, imazethapyr-ammonium, imazosulfuron, indanofan, indaziflam, iofensulfuron, iodosulfuron-methyl, ioxynil, ioxynil octanoate, ioxynil-sodium, ipfencarbazone, iptriazopyrid, isoproturon, isouron, isoxaben, isoxaflutole, isoxachlortole, lactofen, lancotrione, lenacil, linuron, maleic hydrazide, MCPA and its salts (e.g., MCPA-dimethylammonium, MCPA-potassium and MCPA-sodium, esters (e.g., MCPA-2-ethylhexyl, MCPA-butotyl) and thioesters (e.g., MCPA-thioethyl), MCPB and its salts (e.g., MCPB-sodium) and esters (e.g., MCPB-ethyl), mecoprop, mecoprop-P, mefenacet, mefluidide, mesosulfuron-methyl, mesotrione, metam-sodium, metamifop, metamitron, metazachlor, metazosulfuron, methabenzthiazuron, methylarsonic acid and its calcium, monoammonium, monosodium and disodium salts, methyldymron, metobenzuron, metobromuron, metolachlor, S-metolachlor, metosulam, metoxuron, metribuzin, metsulfuron-methyl, molinate, monolinuron, naproanilide, napropamide, napropamide-M, naptalam, neburon, nicosulfuron, norflurazon, orbencarb, orthosulfamuron, oryzalin, oxadiargyl, oxadiazon, oxasulfuron, oxaziclomefone, oxyfluorfen, paraquat dichloride, pebulate, pelargonic acid, pendimethalin, penoxsulam, pentanochlor, pentoxazone, perfluidone, pethoxamid, pethoxyamid, phenmedipham, picloram, picloram-potassium, picolinafen, pinoxaden, piperophos, pretilachlor, primisulfuron-methyl, prodiamine, profoxydim, prometon, prometryn, propachlor, propanil, propaquizafop, propazine, propham, propisochlor, propoxycarbazone, propyrisulfuron, propyzamide, prosulfocarb, prosulfuron, pyraclonil, pyraflufen-ethyl, pyrasulfotole, pyrazogyl, pyrazolynate, pyrazoxyfen, pyrazosulfuron-ethyl, pyribenzoxim, pyributicarb, pyridate, pyriflubenzoxim, pyriftalid, pyriminobac-methyl, pyrimisulfan, pyrithiobac, pyrithiobac-sodium, pyroxasulfone, pyroxsulam, quinclorac, quinmerac, quinoclamine, quizalofop-ethyl, quizalofop-P-ethyl, quizalofop-P-tefuryl, rimsulfuron, saflufenacil, sethoxydim, siduron, simazine, simetryn, sulcotrione, sulfentrazone, sulfometuron-methyl, sulfosulfuron, 2,3,6-TBA, TCA, TCA-sodium, tebutam, tebuthiuron, tefuryltrione, tembotrione, tepraloxydim, terbacil, terbumeton, terbuthylazine, terbutryn, tetflupyrolimet, thenylchlor, thiazopyr, thiencarbazone, thifensulfuron-methyl, thiobencarb, tiafenacil, tiocarbazil, tolpyralate, topramezone, tralkoxydim, tri-allate, triafamone, triasulfuron, triaziflam, tribenuron-methyl, triclopyr, triclopyr-butotyl, triclopyr-triethylammonium, tridiphane, trietazine, trifloxysulfuron, trifludimoxazin, trifluralin, triflusulfuron-methyl, tripyrasulfone, tritosulfuron, vernolate, 3-(2-chloro-3,6-difluorophenyl)-4-hydroxy-1-methyl-1,5-naphthyridin-2(1H)-one, 5-chloro-3-[(2-hydroxy-6-oxo-1-cyclohexen-1-yl)carbonyl]-1-(4-methoxyphenyl)-2(1H)-quinoxalinone, 2-chloro-N-(1-methyl-1H-tetrazol-5-yl)- 6-(trifluoromethyl)-3-pyridinecarboxamide, 7-(3,5-dichloro-4-pyridinyl)-5-(2,2-difluoroethyl)-8-hydroxypyrido[2,3-b]pyrazin-6(5H)-one), 4-(2,6-diethyl-4-methylphenyl)-5-hydroxy-2,6-dimethyl-3(2H)-pyridazinone), 5-[[(2,6-difluorophenyl)methoxy]methyl]-4,5-dihydro-5-methyl-3-(3-methyl-2-thienyl)isoxazole (previously methioxolin), 4-(4-fluorophenyl)-6-[(2-hydroxy-6-oxo-1-cyclohexen-1-yl)carbonyl]-2-methyl-1,2,4-triazine-3,5(2H,4H)-dione, methyl 4-amino-3-chloro-6-(4-chloro-2-fluoro-3-methoxyphenyl)-5-fluoro-2-pyridinecarboxylate, 2-methyl-3-(methylsulfonyl)-N-(1-methyl-1H-tetrazol-5-yl)-4-(trifluoromethyl)benzamide, 2-methyl-N-(4-methyl-1,2,5-oxadiazol-3-yl)-3-(methylsulfinyl)-4-(trifluoromethyl)benzamide, or their environmentally compatible salts, “acids”, esters and amides. Other herbicides also include bioherbicides such as Alternaria destruens Simmons, Colletotrichum gloeosporiodes (Penz.) Penz. & Sacc., Drechsiera monoceras (MTB-951), Myrothecium verrucaria (Albertini & Schweinitz) Ditmar: Fries, Phytophthora palmivora (Butl.) Butl., Puccinia thlaspeos Schub, or their environmentally compatible salts, “acids”, esters and amides.

Non-limiting examples of herbicides also include acetyl-CoA carboxylase inhibitors (ACC), for example cyclohexenone oxime ethers, such as alloxydim, clethodim, cloproxydim, cycloxydim, sethoxydim, tralkoxydim, butroxydim, clefoxydim or tepraloxydim; phenoxyphenoxypropionic esters, such as clodinafop-propargyl, cyhalofopbutyl, diclofop-methyl, fenoxaprop-ethyl, fenoxaprop-P-ethyl, fenthiapropethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl; or arylaminopropionic acids, such as flamprop-methyl or flamprop-isopropyl; p-hydroxyphenylpyruvat-dioxygenase (HPPD)-inhibitors, for example pyrazolynate, pyrazoxyfen, benzofenap, sulcotrione, isoxaflutole, mesotrione, isoxachlortole, ketospiradox, tembotrione; acetolactate synthase inhibitors (ALS), for example imidazolinones, such as imazapyr, imazaquin, imazamethabenz-methyl (imazame), imazamox, imazapic or imazethapyr; pyrimidyl ethers, such as pyrithiobac-acid, pyrithiobac-sodium, bispyribac-sodium or pyribenzoxym; sulfonamides, such as cloransulam, diclosulam, florasulam, flumetsulam, metosulam or penoxsulam; or sulfonylureas, such as amidosulfuron, azimsulfuron, bensulfuron-methyl, chlorimuronethyl, chlorsulfuron, cinosulfuron, cyclosulfamuron, ethametsulfuron-methyl, ethoxysulfuron, flazasulfuron, foramsulfuron, halosulfuron-methyl, imazosulfuron, iodosulfuron, metsulfuron-methyl, nicosulfuron, primisulfuron-methyl, prosulfuron, pyrazosulfuronethyl, rimsulfuron, sulfometuron-methyl or -3-oxetanyl, sulfosulfuron, thifensulfuron-methyl, triasulfuron, tribenuron-methyl, triflusulfuron-methyl or tritosulfuron; amides, for example allidochlor, benzoylprop-ethyl, bromobutide, chlorthiamid, diphenamid, etobenzanid (benzchlomet), fluthiamide, fosamin or monalide; auxin herbicides, for example pyridinecarboxylic acids, such as clopyralid or picloram; 2,4-D or benazolin; auxin transport inhibitors, for example naptalame or diflufenzopyr; carotenoid biosynthesis inhibitors, for example amitrol, diflufenican, fluorochloridone, fluridone, flurtamone, norflurazon or picolinafen; enolpyruvylshikimate-3-phosphate synthase inhibitors (EPSPS), for example glyphosate or sulfosate; glutamine synthetase inhibitors, for example bilanafos (bialaphos) or glufosinate-ammonium; lipid biosynthesis inhibitors, for example anilides, such as anilofos or mefenacet; chloroacetanilides, such as dimethenamid, S-dimethenamid, acetochlor, alachlor, butachlor, butenachlor, diethatyl-ethyl, dimethachlor, metazachlor, metolachlor, S-metolachlor, pretilachlor, propachlor, prynachlor, terbuchlor, thenylchlor or xylachlor; thioureas, such as butylate, cycloate, di-allate, dimepiperate, EPTC, esprocarb, molinate, pebulate, prosulfocarb, thiobencarb (benthiocarb), tri-allate or vemolate; or benfuresate or perfluidone; mitosis inhibitors, for example carbamates, such as asulam, carbetamid, chlorpropham, orbencarb, propyzamid, propham or tiocarbazil; dinitroanilines, such as benefin, butralin, dinitramin, ethalfluralin, fluchloralin, oryzalin, pendimethalin, prodiamine or trifluralin; pyridines, such as dithiopyr or thiazopyr; or butamifos, chlorthal-dimethyl (DCPA) or maleic hydrazide; protoporphyrinogen IX oxidase inhibitors, for example diphenyl ethers, such as acifluorfen, acifluorfen-sodium, aclonifen, bifenox, chlornitrofen (CNP), ethoxyfen, fluorodifen, fluoroglycofen-ethyl, fomesafen, furyloxyfen, lactofen, nitrofen, nitrofluorfen or oxyfluorfen; oxadiazoles, such as oxadiargyl or oxadiazon; cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin; or pyrazoles, such as ET-751, JV 485 or nipyraclofen; photosynthesis inhibitors, for example propanil, pyridate or pyridafol; benzothiadiazinones, such as bentazone; dinitrophenols, for example bromofenoxim, dinoseb, dinoseb-acetate, dinoterb or DNOC; dipyridylenes, such as cyperquat-chloride, difenzoquat-methylsulfate, diquat or paraquat-dichloride; ureas, such as chlorbromuron, chlorotoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron or tebuthiuron; phenols, such as bromoxynil or ioxynil; chloridazon; triazines, such as ametryn, atrazine, cyanazine, desmetryn, dimethamethryn, hexazinone, prometon, prometryn, propazine, simazine, simetryn, terbumeton, terbutryn, terbutylazine or trietazine; triazinones, such as metamitron or metribuzin; uracils, such as bromacil, lenacil or terbacil; or biscarbamates, such as desmedipham or phenmedipham; growth substances, for example aryloxyalkanoic acids, such as 2,4-DB, clomeprop, dichlorprop, dichlorprop-P (2,4-DP-P), fluoroxypyr, MCPA, MCPB, mecoprop, mecoprop-P or triclopyr; benzoic acids, such as chloramben or dicamba; or quinolinecarboxylic acids, such as quinclorac or quinmerac; cell wall synthesis inhibitors, for example isoxaben or dichlobenil; various other herbicides, for example dichloropropionic acids, such as dalapon; dihydrobenzofurans, such as ethofumesate; henylacetic acids, such as chlorfenac (fenac); or aziprotryn, barban, bensulide, benzthiazuron, benzofluor, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid or trimeturon; or their environmentally compatible salts, “acids”, esters and amides.

### Insects

In some embodiments, the insects are phytophagous insects. Phytophagous insects refers to invertebrate pests causing injury to plants by feeding upon them, such as by eating foliage, stem, root, leaf, flower, pod, fruit or seed tissue or any other vegetative or reproductive plant structure, or by sucking the vascular juices of plants. Leaf feeders may be external (exophytic) or they may mine the tissues, sometimes even specializing on a particular cell type. There are phytophagous insect species in the majority of insect orders, including Hemiptera, Thysanoptera, Orthoptera, Lepidoptera, Coleoptera, Heteroptera, Hymenoptera, and Diptera.

Examples of agronomic or nonagronomic invertebrate pests include eggs, larvae and adults of the order Lepidoptera, such as armyworms, cutworms, loopers, and heliothines in the family Noctuidae (e.g., pink stem borer (Sesamia inferens Walker), corn stalk borer (Sesamia nonagrioides Lefebvre), southern armyworm (Spodoptera eridania Cramer), fall armyworm (Spodoptera frugiperda J. E. Smith), beet armyworm (Spodoptera exigua Hübner), cotton leafworm (Spodoptera littoralis Boisduval), yellowstriped armyworm (Spodoptera ornithogalli Guenee), black cutworm (Agrotis ipsilon Hufnagel), velvetbean caterpillar (Anticarsia gemmatalis Hübner), green fruitworm (Lithophane antennata Walker), cabbage armyworm (Barathra brassicae Linnaeus), soybean looper (Pseudoplusia includens Walker), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), com root webworm (Crambus caliginosellus Clemens), sod webworms (Pyralidae: Crambinae) such as sod worm (Herpetogramma licarsisalis Walker), sugarcane stem borer (Chilo infuscatellus Snellen), tomato small borer (Neoleucinodes elegantalis Guenee), green leafroller (Cnaphalocrocis medinalis), grape leaffolder (Desmia funeralis Hübner), melon worm (Diaphania nitidalis Stoll), cabbage center grub (Helluala hydralis Guenee), yellow stem borer (Scirpophaga incertulas Walker), early shoot borer (Scirpophaga infuscatellus Snellen), white stem borer (Scirpophaga innotata Walker), top shoot borer (Scirpophaga nivella Fabricius), dark-headed rice borer (Chilo polychrysus Meyrick), striped riceborer (Chilo suppressalis Walker), cabbage cluster caterpillar (Crocidolomia binotalis English)); leafrollers, budworms, seed worms, and fruit worms in the family Tortricidae (e.g., codling moth (Cydia pomonella Linnaeus), grape berry moth (Endopiza viteana Clemens), oriental fruit moth (Grapholita molesta Busck), citrus false codling moth (Cryptophlebia leucotreta Meyrick), citrus borer (Ecdytolopha aurantiana Lima), redbanded leafroller (Argyrotaenia velutinana Walker), obliquebanded leafroller (Choristoneura rosaceana Harris), light brown apple moth (Epiphyas postvittana Walker), European grape berry moth (Eupoecilia ambiguella Hübner), apple bud moth (Pandemis pyrusana Kearfott), omnivorous leafroller (Platynota stultana Walsingham), barred fruit-tree tortrix (Pandemis cerasana Hübner), apple brown tortrix (Pandemis heparana Denis & Schiffermüller)); and many other economically important lepidoptera (e.g., diamond back moth (Plutella xylostella Linnaeus), pink bollworm (Pectinophora gossypiella Saunders), gypsy moth (Lymantria dispar Linnaeus), peach fruit borer (Carposina niponensis Walsingham), peach twig borer (Anarsia lineatella Zeller), potato tuberworm (Phthorimaea operculella Zeller), spotted teniform leafminer (Lithocolletis blancardella Fabricius), Asiatic apple leafminer (Lithocolletis ringoniella Matsumura), rice leaffolder (Lerodea eufala Edwards), apple leafminer (Leucoptera scitella Zeller)); eggs, nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fabricius)), smoky brown cockroach (Periplaneta fuliginosa Service), Australian Cockroach (Periplaneta australasiae Fabr.), lobster cockroach (Nauphoeta cinerea Olivier) and smooth cockroach (Symploce pallens Stephens)); eggs, foliar feeding, fruit feeding, root feeding, seed feeding and vesicular tissue feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus)), annual bluegrass weevil (Listronotus maculicollis Dietz), bluegrass billbug (Sphenophorus parvulus Gyllenhal), hunting billbug (Sphenophorus venatus vestitus), Denver billbug (Sphenophorus cicatristriatus Fahraeus)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera LeConte)); chafers and other beetles from the family Scarabaeidae (e.g., Japanese beetle (Popillia japonica Newman), oriental beetle (Anomala orientalis Waterhouse, Exomala orientalis (Waterhouse) Baraud), northern masked chafer (Cyclocephala borealis Arrow), southern masked chafer (Cyclocephala immaculata Olivier or C. lurida Bland), dung beetle and white grub (Aphodius spp.), black turfgrass ataenius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowsky)); carpet beetles from the family Dermestidae; wireworms from the family Elateridae; bark beetles from the family Scolytidae and flour beetles from the family Tenebrionidae.

In addition, agronomic and nonagronomic pests include: eggs, adults and larvae of the order Dermaptera including earwigs from the family Forficulidae (e.g., European earwig (Forficula auricularia Linnaeus), black earwig (Chelisoches morio Fabricius)); eggs, immatures, adults and nymphs of the orders Hemiptera and Homoptera such as, plant bugs from the family Miridae, cicadas from the family Cicadidae, leafhoppers (e.g. Empoasca spp.) from the family Cicadellidae, potato leafhoppers, bed bugs (e.g., Cimex lectularius Linnaeus) from the family Cimicidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, chinch bugs (e.g., hairy chinch bug (Blissus leucopterus hirtus Montandon) and southern chinch bug (Blissus insularis Barber)) and other seed bugs from the family Lygaeidae, spittlebugs from the family Cercopidae squash bugs from the family Coreidae, and red bugs and cotton stainers from the family Pyrrhocoridae.

Agronomic and nonagronomic pests also include: eggs, larvae, nymphs and adults of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)); flat mites in the family Tenuipalpidae (e.g., citrus flat mite (Brevipalpus lewisi McGregor)); rust and bud mites in the family Eriophyidae and other foliar feeding mites and mites important in human and animal health, i.e. dust mites in the family Epidermoptidae, follicle mites in the family Demodicidae, grain mites in the family Glycyphagidae; ticks in the family Ixodidae, commonly known as hard ticks (e.g., deer tick (Ixodes scapularis Say), Australian paralysis tick (Ixodes holocyclus Neumann), American dog tick (Dermacentor variabilis Say), lone star tick (Amblyomma americanum Linnaeus)) and ticks in the family Argasidae, commonly known as soft ticks (e.g., relapsing fever tick (Ornithodoros turicata), common fowl tick (Argas radiatus)); scab and itch mites in the families Psoroptidae, Pyemotidae, and Sarcoptidae; eggs, adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria Linnaeus), bush locust (Zonocerus spp.), house cricket (Acheta domesticus Linnaeus), mole crickets (e.g., tawny mole cricket (Scapteriscus vicinus Scudder) and southern mole cricket (Scapteriscus borelhi Giglio-Tos)); eggs, adults and immatures of the order Diptera including leafminers (e.g., Liriomyza spp. such as serpentine vegetable leafminer (Liriomyza sativae Blanchard)), midges, fruit flies (Tephritidae), frit flies (e.g., Oscinella frit Linnaeus), soil maggots, house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera; eggs, adults and immatures of the order Thysanoptera including onion thrips (Thrips tabaci Lindeman), flower thrips (Frankliniella spp.), and other foliar feeding thrips; insect pests of the order Hymenoptera including ants of the Family Formicidae including the Florida carpenter ant (Camponotus floridanus Buckley), red carpenter ant (Camponotus ferrugineus Fabricius), black carpenter ant (Camponotus pennsylvanicus De Geer), white-footed ant (Technomyrmex albipes fr. Smith), big headed ants (Pheidole sp.), ghost ant (Tapinoma melanocephalum Fabricius); Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Forster) and odorous house ant (Tapinoma sessile Say). Other Hymenoptera including bees (including carpenter bees), hornets, yellow jackets, wasps, and sawflies (Neodiprion spp.; Cephus spp.); insect pests of the order Isoptera including termites in the Termitidae (e.g., Macrotermes sp., Odontotermes obesus Rambur), Kalotermitidae (e.g., Cryptotermes sp.), and Rhinotermitidae (e.g., Reticulitermes sp., Coptotermes sp., Heterotermes tenuis Hagen) families, the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus).

Examples of invertebrate pests of stored grain include larger grain borer (Prostephanus truncatus), lesser grain borer (Rhyzopertha dominica), rice weevil (Stiophilus oryzae), maize weevil (Stiophilus zeamais), cowpea weevil (Callosobruchus maculatus), red flour beetle (Tribolium castaneum), granary weevil (Stiophilus granarius), Indian meal moth (Plodia interpunctella), Mediterranean flour beetle (Ephestia kuhniella) and flat or rusty grain beetle (Cryptolestis ferrugineus).

Compositions of the present disclosure may have activity on members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e. root knot nematodes in the genus Meloidogyne, lesion nematodes in the genus Pratylenchus, stubby root nematodes in the genus Trichodorus, etc.) and animal and human health pests (i.e. all economically important flukes, tapeworms, and roundworms, such as Strongylus vulgaris in horses, Toxocara canis in dogs, Haemonchus contortus in sheep, Dirofilaria immitis Leidy in dogs, Anoplocephala perfoliata in horses, Fasciola hepatica Linnaeus in ruminants, etc.).

Compositions of the disclosure may have activity against pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guenée (rice leaf roller), Crambus caliginosellus Clemens (com root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Hübner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermüller (grape berry moth), Pectinophora gossypiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamond back moth), Spodoptera exigua Hübner (beet armyworm), Spodoptera litura Fabricius (tobacco cutworm, cluster caterpillar), Spodoptera frugiperda J. E. Smith (fall armyworm), Trichoplusia ni Hübner (cabbage looper) and Tuta absoluta Meyrick (tomato leafminer)).

Compositions of the disclosure may have significant activity on members from the order Homoptera including: Acyrthosiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosiphum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stål (rice leafhopper), Nilaparvata lugens Stål (brown planthopper), Peregrinus maidis Ashmead (com planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla).

Compositions of this disclosure also may have activity on members from the order Hemiptera including: Acrosternum hilare Say (green stink bug), Anasa tristis De Geer (squash bug), Blissus leucopterus Say (chinch bug), Cimex lectularius Linnaeus (bed bug) Corythuca gossypii Fabricius (cotton lace bug), Cyrtopeltis modesta Distant (tomato bug), Dysdercus suturellus Herrich-Schäffer (cotton stainer), Euchistus servus Say (brown stink bug), Euchistus variolarius Palisot de Beauvois (one-spotted stink bug), Graptosthetus spp. (complex of seed bugs), Halymorpha halys Stäl (brown marmorated stink bug), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the disclosure include Thysanoptera (e.g., Frankliniella occidentalis Pergande (western flower thrips), Scirthothrips citri Moulton (citrus thrips), Sericothrips variabilis Beach (soybean thrips), and Thrips tabaci Lindeman (onion thrips); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

In some aspects, the compositions of the disclosure are useful for controlling Western Flower Thrips (Frankliniella occidentalis). In some aspects, the compositions of the disclosure are useful for controlling potato leafhopper (Empoasca fabae). In some aspects, the compositions of the disclosure are useful for controlling cotton melon aphid (Aphis gossypii). In some aspects, the compositions of the disclosure are useful for controlling diamond backmoth (Plutella xylostella L.). In some aspects, the compositions of the disclosure are useful for controlling Silverleaf Whitefly (Bemisia argentifolii Bellows & Perring).

In cyantraniliprole aspects of the disclosure, the compositions of the disclosure are effective against Coleoptera, Chrysomelidae, Cerotoma trifurcata bean leaf beetle, Chaetocnema concinna beet flea beetle, Epilachna varivestis Mexican bean beetle, Epitrix cucumeris potato flea beetle, Leptinotarsa decemlineata Colorado potato beetle, Oulema melanopus cereal leaf beetle, Oulema oryzae rice leaf beetle, Phyllotreta cruciiferae cabbage flea beetle, Phyllotreta striolata striped flea beetle, Psylliodes spp. flea beetles, Curculionidae, Anthonomus eugenii pepper weevil, Ceutorhynchus napi cabbage stem weevil, Ceutorhynchus quadridens cabbage seed-stalk curculio, Conotrachelus nenuphar plum curculio, Hypera bruneipennis Egyptian alfalfa weevil, Hypera postica alfalfa weevil, Lissorhoptrus oryzophilus rice water weevil, Nitidulidae, Meligethes aeneus pollen beetle, blossom beetle, Scarabaeidae, Cotinis nitida green June beetle, Phyllophaga spp. June beetles, grubs, Popillia japonica Japanese beetle, Diptera, Agromyzidae, Liromyza chinensis stone leek leafminer, Liromyza huidobrensis pea leafminer, Liriomyza sativae serpentine/vegetable leafminer, Liromyza trifolii American serpentine leafminer, Anthomyiidae, Delia antiqua onion fly, Delia platura seedcorn maggot, Muscidae, Atherigona oryzae rice seedling fly, Psilidae, Psila rosae carrot fly, Tephritidae, Anastrepha fraterculus South American fruit fly, Anastrepha ludens Mexican fruit fly, Anasterpha striata guava fruit fly, Bactrocera cucurbitae melon fly, Bactrocera dorsalis oriental fruit fly, Bactrocera oleae olive fly, Ceratitis capitata Mediterranean fruit fly, Chromatomyia horticola garden pea leafminer, Rhagoletis cerasi cherry fruit fly, Rhagoletis cingulata cherry fruit fly, Rhagoletis indifferens western cherry fruit fly, Rhagoletis pomonella apple maggot, Hemiptera, Aleyrodidae, Aleyrodes proletella cabbage whitefly, Bemisia tabaci sweet potato whitefly, cotton whitefly, Dialeurodes citri citrus whitefly, Trialeurodes vaporariorum, greenhouse whitefly, Aphididae, Acyrthosiphon pisum pea aphid, Aphis craccivora cowpea aphid, Aphis fabae black bean aphid, Aphis glycines soybean aphid, Aphis gossypii cotton aphid, melon aphid, Aphis nasturtii buckthorn aphid, Aphis pomi green apple aphid, Aphis spiraceola spirea aphid, Aulacorthum solani foxglove aphid, Brachycaudus persicae black peach aphid, Brevicoryne brassicae cabbage aphid, Chromaphis juglandicola European walnut aphid, Dysaphis plantaginea rosy apple aphid, Hyalopterus pruni mealy plum aphid, Lipaphis erysimi mustard aphid, turnip aphid, Macrosiphum euphorbiae potato aphid, Myzus persicae green peach aphid, peach potato aphid, Rhopalosiphum padi bird cherry oat aphid, Rhopalosiphum nymphaeae plum aphid, Schizaphis graminum greenbug, Sitobion avenae English grain aphid, Therioaphis maculata spotted alfalfa aphid, Toxoptera citricida brown citrus aphid, oriental citrus aphid, Cicadellidae, Empoasca fabae leafhopper/jassid complex, Empoasca vitis green frogfly, Hortensia similis common green leafhopper, Idioscopus spp. mango leafhopper, Jacobiasca lybica cotton jassid, Nephotettix spp. rice green leafhopper complex, Typhlocyba rosae rose leafhopper, Typhlocyba pomaria white apple leafhopper, Coreidae Leptocorisa oratorius rice bug, rice ear bug, paddy bug, Delphacidae, Nilaparvata lugens rice brown planthopper, Diaspididae, Aonidiella aurantii citrus scale, Flatidae, Metcalfa pruinosa citrus flatid planthopper, Pentatomidae, Euschistus spp. brown stinkbugs, Edessa spp. stink bugs, Psyllidae, Diaphorina citri Asian citrus psyllid, Paratrioza cockerelli potato psyllid, tomato psyllid, Trioza eugeniae eugenia psyllid, lillypilly psyllid, Hymenoptera Tenthredinidae, Hoplocampa testudinea European apple sawfly, Lepidoptera, Crambidae, Scirpophaga incertulas yellow (rice) stemborer, Gelechiidae, Anarsia lineatella peach twig borer, Keiferia lycopersicella tomato pinworm, Pectinophora gossypiella pink bollworm, Tuta absoluta tomato leafminer, Gracillariidae, Gracillaria theivora tea leafroller, Phyllonorycter blancardella spotted tentiform leafminer, Phyllonorycter coryfoliella nut leaf blister moth, Phyllonorycter crataegella apple blotch leafminer, Phyllonorycter ringoniella apple leafminer, Phyllonorycter elmaella western tentiform leafminer, Hesperiidae, Borbo cinara rice leafroller, Lyonetiidae, Leucoptera coffeella white coffee leafminer, Leucoptera scitella pear leaf blister moth, Lyonetia clerkella peach, leaf miner, Noctuidae, Agrotis segetum common cutworm, Alabama argillacea cotton leafworn, Autographa californica alfalfa looper, Barathra brassicae cabbage armyworm, Chrysodeixis chalcites green garden looper, Chrysodeixis eriosoma green semi-looper, Earias insulana Egyptian bollworm, Earias vittella northern rough bollworm, Feltia subterranea granulate cutworm, Helicoverpa armigera American bollworm, cotton bollworm, Helicoverpa punctigera climbing cutworm, Heliothis virescens tobacco budworm, Helicoverpa zea corn earworm, Prodenia omithogalli yellow-striped armyworm, Pseudaletia unipuncta true armyworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistidae, Phyllocnistis citrella citrus leafminer, Pieridae, Colias eurytheme alfalfa caterpillar, Leptophobia aripa green-eyed white, Pieris brassicae cabbage butterfly, large white, Pieris rapae imported cabbage worm, cabbage white, Plutellidae, Plutella xylostella diamondback moth, Pyralidae, Chilo suppressalis Asiatic rice stemborer, Cnaphalocerus medinalis rice leaffolder, Crocidolomia binotalis cabbage caterpillar, Desmia funeralis grape leaffolder, Diaphania indica cotton caterpillar, Diaphania nitidaltis melonworm, Hellula hydralis cabbage center grub, Hellula undalis cabbage webworm, Lerodea eufala rice leaffolder, Leucinodes orbonalis brinjal fruit borer, Maruca testulalis bean pod borer, Neoleucinodes elegantalis small tomato borer, Nymphula depunctalis rice caseworm, Ostrinia furnicalis Asian corn borer, Ostrinia nubilalis European corn borer, Sphingidae, Manduca sexta tomato hornworm, tobacco hornworm, Smerinthus spp. sphinx moths, Tortricidae, Adoxophyes orana summer fruit tortrix, Argyrotaenia pulchellana grape tortrix, Argyrotaenia velutinana red-banded leafroller, Choristoneura rosaceana oblique-banded leafroller, Eupoecilia ambiguella grape berry moth, Cydia pomonella codling moth, Cydia prunivora lesser apple worm, Grapholita molesta oriental fruit moth, Lobesia botrana grape vine moth, Pandemis heparana apple brown tortrix, Pandemis limitata three-lined leaf roller, Paramyelois transitella navel orangeworm, Platynota idaeusalis tufted apple bud moth, Platynota stultana omnivorus leafroller, Thysanoptera, Thripidae, Enneothrips flavens, Frankliniella fusca tobacco thrips, Frankliniella intonsa European flower thrips, Frankliniella occidentalis western flower thrips, Frankliniella schultzei common blossom thrips, Frankliniella tritici eastern flower thrips, Megalurothrips sjostedti cowpea thrips, Megalurothrips usitatus bean blossom thrips, Scirthothrips citri citrus thrips, Scirthothrips dorsalis yellow tea thrips, chilli thrips, Sericothrips variabilis soybean thrips, Stenchaetothrips biformis oriental rice thrips, Thrips arizonensis cotton thrips, Thrips meridionalis peach thrips, Thrips palmi melon thrips, and Thrips tabaci onion thrips, common cotton thrips.

In some cyantraniliprole aspects, of the disclosure, the compositions of the disclosure are effective against Leptinotarsa decemlineata Colorado potato beetle, Oulema oryzae rice leaf beetle, Phyllotreta cruciiferae cabbage flea beetle, Phyllotreta striolata striped flea beetle, Psylliodes spp. flea beetles, Anthonomus eugenii pepper weevil, Conotrachelus nenuphar plum curculio, Lissorhoptrus oryzophilus rice water weevil, Meligethes aeneus pollen beetle, blossom beetle, Liromyza chinensis stone leek leafminer, Liromyza huidobrensis pea leafminer, Liriomyza sativae serpentine/vegetable leafminer, Liromyza trifolii American serpentine leafminer, Delia antiqua onion fly, Delia platura seedcorn maggot, Psila rosae carrot fly, Bactrocera dorsalis oriental fruit fly, Bactrocera oleae olive fly, Ceratitis capitata Mediterranean fruit fly, Rhagoletis indifferens western cherry fruit fly, Rhagoletis pomonella apple maggot, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis fabae black bean aphid, Aphis gossypii cotton aphid, melon aphid, Aphis pomi green apple aphid, Aphis spiraceola spirea aphid, Aulacorthum solani foxglove aphid, Brevicoryne brassicae cabbage aphid, Dysaphis plantaginea rosy apple aphid, Lipaphis erysimi mustard aphid, turnip aphid, Macrosiphum euphorbiae potato aphid, Myzus persicae green peach aphid, peach potato aphid, Rhopalosiphum padi bird cherry oat aphid, Schizaphis graminum greenbug, Sitobion avenae English grain aphid, Toxoptera citricida brown citrus aphid, oriental citrus aphid, Empoasca vitis green frogfly, Idioscopus spp. mango leafhopper, Nilaparvata lugens rice brown planthopper, Aonidiella aurantii citrus scale, Euschistus spp. brown stinkbugs, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea corn earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistis citrella citrus leafminer, Pieris brassicae cabbage butterfly, large white, Pieris rapae imported cabbage worm, cabbage white, Plutella xylostella diamondback moth, Chilo suppressalis Asiatic rice stemborer, Cnaphalocerus medinalis rice leaffolder, Leucinodes orbonalis brinjal fruit borer, Ostrinia furnicalis Asian corn borer, Ostrinia nubilalis European corn borer, Choristoneura rosaceana oblique-banded leafroller, Eupoecilia ambiguella grape berry moth, Cydia pomonella codling moth, Grapholita molesta oriental fruit moth, Lobesia botrana grape vine moth, Frankliniella fusca tobacco thrips, Frankliniella intonsa European flower thrips, Frankliniella occidentalis western flower thrips, Scirthothrips citri citrus thrips, Scirthothrips dorsalis yellow tea thrips, chilli thrips, Thrips palmi melon thrips, and Thrips tabaci onion thrips, common cotton thrips.

In some cyantraniliprole aspects of the disclosure, the compositions of the disclosure are effective against Conotrachelus nenuphar plum curculio, Liromyza huidobrensis pea leafminer, Liriomyza sativae serpentine/vegetable leafminer, Liromyza trifolii American serpentine leafminer, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis gossypii cotton aphid, melon aphid, Brevicoryne brassicae cabbage aphid, Dysaphis plantaginea rosy apple aphid, Myzus persicae green peach aphid, peach potato aphid, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea com earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Phyllocnistis citrella citrus leafminer, Plutella xylostella diamondback moth, Chilo suppressalis Asiatic rice stemborer, Cnaphalocerus medinalis rice leaffolder, Choristoneura rosaceana oblique-banded leafroller, Eupoecilia ambiguella grape berry moth, Cydia pomonella codling moth, Grapholita molesta oriental fruit moth, Lobesia botrana grape vine moth, Frankliniella fusca tobacco thrips, Frankliniella occidentalis western flower thrips, Scirthothrips dorsalis yellow tea thrips, chilli thrips, Thrips palmi melon thrips, and Thrips tabaci onion thrips, common cotton thrips.

In chlorantraniliprole aspects of the disclosure, the compositions of the disclosure are effective against: Coleoptera (Chrysomelida, Leptinotarsa decemlineata Colorado potato beetle, Curculionidae, Lissorhoptrus oryzophilus rice water weevil, Listronotus maculicollis annual bluegrass weevil, Oryzophagus oryzae rice water weevil, Sphenophorus spp. Billbug, Scarabaeidae Ataenius spretulus black turfgrass ataenius, Aphodius spp. scarab beetles, Cotinis nitida green June beetle, Cyclocephala spp. masked chafers, Exomala orientalis oriental beetle grub, Maladera castanea Asiatic garden beetle, Phyllophaga spp. June beetles, Popillia japonica Japanese beetle, and Rhizotrogus majalis European chafer); Diptera (Agromyzidae, Chromatomyia horticola garden pea leafminer, and Liriomyza spp. Leafminers); Hemiptera (Aleyrodidae, Bemisia spp. Whitefly, Trialeurodes abutiloneus bandedwinged whitefly, Cicadellidae, and Typhlocyba pomaria white apple leafhopper); Isoptera (Rhinotermitidae, Heterotermes tenuis sugarcane termite, Termitidae, Microtermes obesi sugarcane termite, and Odontotermes obesus sugarcane termite); and Lepidoptera (Arctiidae, Estigmene acrea saltmarsh caterpillar, Crambidae, Achyra rantalis garden webworm, Desmia funeralis grape leaffolder, Ostrinia nubilalis European corn borer, Gelechiidae, Anarsia lineatella peach twig borer, Keiferia lycopersicella tomato pinworm, Phthorimaea operculella potato tuberworm, Tuta absoluta S. American tomato pinworm, Geometridae, Operophthera brumata winter moth, Gracilaridae, Phyllocnistis citrella citrus leafminer, Lithocolletis ringoniella apple leafminer, Phyllonorycter blancardella spotted tentiform leafminer, Lyonetidae, Leucoptera spp. (ie: malifoliella, coffeella) coffee leafminer, pear leaf blister moth, Noctuidae, Agrotis ipsilon black cutworm, Alabama argillacea cotton leafworm, Amphipyra pyramidoides humped green fruitworm, Anticarsia gemmatalis velvetbean caterpillar, Autographa gamma common silver Y moth, Barathra brassicae cabbage armyworm, Earias spp. (ie: huegeliana, insulana, vitella) rough, spiny, northern rough bollworm, Helicoverpa spp. (ie: armigera, punctigera, zea) bollworms/budworms/fruitworms, Heliothis virescens tobacco budworm, Lithophane antennata green fruitworm, Mamestra brassicae cabbage moth, Orthosia hibisci green fruitworm, Phalaenoides glycinae grape vine moth, Phytometra acuta tomato semi-looper, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieridae, Pieris spp. (ie: brassica, rapae) large white, imported cabbageworm, Plutellidae, Plutella xylostella diamondback moth, Pyralidae, Amyelois transitella navel orangeworm, Chilo spp. (ie: infuscatellus, polychrysus, suppressalis) sugarcane/rice stem borers, Cnaphalocrocis medinalis rice leafroller, Crambus spp. sod webworm, Crocidolomia binotalis cabbage cluster caterpillar, Diaphania spp. (ie: hyalinata, nitidalis) melonworm, pickleworm, Diatraea saccharalis, Brazilian sugarcane borer, Elasmopalpus lignosellus lesser stalk borer, Evergestis rimosalis cross-stripped cabbageworm, Hedylepta indicata soybean leaffolder, Hellula spp. (ie: hydralis, undalis) cabbage centre-grub, cabbage webworm, Leucinodes orbonalis eggplant shoot and fruit borer, Maruca spp. pod borer, Neoleucinodes elegantalis tomato small borer, Scirpophaga spp. sugarcane/rice stem borer, Sesamia spp. (ie: inferens, nonagrioides) pink stem borer/com stalk borer, Sphingidae, Manduca spp. (ie: quinquemaculata, sexta) tomato/tobacco hornworm, Tortricidae, Adoxophyes orana summer fruit tortrix, Argyrotaenia spp. (ie: pulchellana, velutinana) grape tortrix, redbanded leafroller, Bonagota cranaodes Brazilian apple leafroller, Carposina spp. (ie: niponensis, sasaki) peach fruit borer, peach fruit moth, Choristoneura rosaceana obliquebanded leafroller, Cryptophlebia leucotreta false codling moth, Cydia pomonella codling moth, Ecdytolopha aurantiana citrus borer, Endopiza vitana grape berry moth, Epiphyas postvittana light brown apple moth, Eupoecilia ambiguella European grape berry moth, Grapholita molesta oriental fruit moth, Lobesia botrana European grapevine moth, Pandemis spp. (ie: cerasana, heparana, barred fruit tree tortrix, limitata, pyrusana) apple brown tortrix, three-lined leafroller, apple pandemic, Platynota spp. (ie: idaeusalis, stultana) tufted apple bud moth, omnivorous leafroller, Zygaenidae, and Harrisina spp. (ie: americana, brillians) grapeleaf/western grapeleaf skeletonizer).

In some chlorantraniliprole aspects of the disclosure, the compositions of the disclosure are effective against: Leptinotarsa decemlineata Colorado potato beetle, Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Phthorimaea operculella potato tuberworm, Tuta absoluta S. American tomato pinworm, Phyllocnistis citrella citrus leafminer, Phyllonorycter blancardella spotted tentiform leafminer, Leucoptera spp. (ie: malifoliella, coffeella) coffee leafminer, Agrotis ipsilon black cutworm, Alabama argillacea cotton leafworm, Anticarsia gemmatalis velvetbean caterpillar, Helicoverpa spp. (ie: armigera, punctigera, zea) bollworms/budworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieris spp. (ie: brassica, rapae) large white, imported cabbageworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer, Leucinodes orbonalis eggplant shoot and fruit borer, Scirpophaga spp. sugarcane/rice stem borer, Sesamia spp. (ie: inferens, nonagrioides) pink stem borer/corn stalk borer, Carposina spp. (ie: niponensis, sasaki) peach fruit borer, peach fruit moth, Choristoneura rosaceana obliquebanded leafroller, Cydia pomonella codling moth, Eupoecilia ambiguella European grape berry moth, Grapholita molesta oriental fruit moth, and Lobesia botrana European grapevine moth.

In some chlorantraniliprole aspects of the disclosure, the compositions of the disclosure are effective against: Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Tuta absoluta S. American tomato pinworm, Anticarsia gemmatalis velvetbean caterpillar, Helicoverpa spp. (ie: armigera, punctigera, zea) bollworms/budworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer, Scirpophaga spp. sugarcane/rice stem borer, Sesamia spp. (ie: inferens, nonagrioides) pink stem borer/corn stalk borer, Cydia pomonella codling moth, Grapholita molesta oriental fruit moth, and Lobesia botrana European grapevine moth.

### Plants

The present compositions are useful for protecting agronomic field crops other non-agronomic horticultural crops and plants from phytophagous invertebrate pests. This utility includes protecting crops and other plants (i.e. both agronomic and nonagronomic) that contain genetic material introduced by genetic engineering (i.e. transgenic) or modified by mutagenesis to provide advantageous traits. Examples of such traits include tolerance to herbicides, resistance to phytophagous pests (e.g., insects, mites, aphids, spiders, nematodes, snails, plant-pathogenic fungi, bacteria and viruses), improved plant growth, increased tolerance of adverse growing conditions such as high or low temperatures, low or high soil moisture, and high salinity, increased flowering or fruiting, greater harvest yields, more rapid maturation, higher quality and/or nutritional value of the harvested product, or improved storage or process properties of the harvested products. Transgenic plants can be modified to express multiple traits. Examples of plants containing traits provided by genetic engineering or mutagenesis include varieties of corn, cotton, soybean and potato expressing an insecticidal Bacillus thuringiensis toxin such as YIELD GARD®, KNOCKOUT®, STARLINK®, BOLLGARD®, NuCOTN® and NEWLEAF®, INVICTA RR2 PRO™, and herbicide-tolerant varieties of corn, cotton, soybean and rapeseed such as ROUNDUP READY®, LIBERTY LINK®, IMI®, STS® and CLEARFIELD®, as well as crops expressing N-acetyltransferase (GAT) to provide resistance to glyphosate herbicide, or crops containing the HRA gene providing resistance to herbicides inhibiting acetolactate synthase (ALS). The present compositions may interact synergistically with traits introduced by genetic engineering or modified by mutagenesis, thus enhancing phenotypic expression or effectiveness of the traits or increasing the invertebrate pest control effectiveness of the present compounds and compositions. In particular, the present compositions may interact synergistically with the phenotypic expression of proteins or other natural products toxic to invertebrate pests to provide greater-than-additive control of these pests, i.e. produce a combined effect greater than the sum of their separate effects.

Plants within the scope of the present disclosure include crops, vegetables, fruits, trees other than fruit trees, lawn, and other uses (flowers, biofuel plants and ornamental foliage). Crops include: corn, rice, wheat, barley, rye, oat, sorghum, cotton, soybean, peanut, buckwheat, beet, rapeseed, sunflower, sugar cane, tobacco, and others known in the art. Vegetables include: solanaceous vegetables (for example, eggplant, tomato, pimento, pepper and potato); cucurbitaceous vegetables (for example, cucumber, pumpkin, zucchini, water melon, and melon); cruciferous vegetables (for example, Japanese radish, white turnip, horseradish, kohlrabi, Chinese cabbage, cabbage, leaf mustard, broccoli, and cauliflower); asteraceous vegetables (for example, burdock, crown daisy, artichoke and lettuce); liliaceous vegetables (for example, green onion, onion, garlic and asparagus); ammiaceous vegetables (for example, carrot, parsley, celery and parsnip); chenopodiaceous vegetables (for example, spinach and Swiss chard); and lamiaceous vegetables (for example, Perilla frutescens, mint and basil). Fruits include: pomaceous fruits (for example, apple, pear, Japanese pear, Chinese quince and quince); stone fleshy fruits (for example, peach, plum, nectarine, Prunus mume, cherry fruit, apricot and prune); citrus fruits (for example, Citrus unshiu, orange, lemon, lime and grapefruit); nuts (for example, chestnut, walnuts, hazelnuts, almond, pistachio, cashew nuts and macadamia nuts); berry fruits (for example, blueberry, cranberry, blackberry, strawberry, and raspberry); grape; kaki; persimmon; olive; Japanese plum; banana; coffee; date palm; coconuts; and oil palm. Trees other than fruit trees include: tea; mulberry; and other trees (for example, ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, Taxus cuspidate, elm and Japanese horse chestnut), Sweet viburnum, Podocarpus macrophyllus, Japanese cedar, Japanese cypress, croton, Japanese spindletree, and Photinia glabra). Lawn uses include: sods (for example, Zoysia japonica, Zoysia matrella); bermudagrasses; bent grasses; festucae; ryegrasses. Flower uses include: rose, carnation, chrysanthemum, Eustoma, gypsophila, gerbera, marigold, salvia, petunia, verbena, tulip, aster, gentian, lily, pansy, cyclamen, orchid, lily of the valley, lavender, stock, ornamental cabbage, primula, poinsettia, gladiolus, cattleya, daisy, cymbidium and begonia. Bio-fuel plants include: jatropha, safflower, Camelina, switch grass, Miscanthus giganteus, Phalaris arundinacea, Arundo donax, kenaf, cassava, and willow.

### Non-Agronomic Uses

Non-agronomic uses refer to invertebrate pest control in the areas other than fields of crop plants. Nonagronomic uses of the present compositions include control of invertebrate pests in stored grains, beans and other foodstuffs, and in textiles such as clothing and carpets. Nonagronomic uses of the present compositions also include invertebrate pest control in ornamental plants, forests, in yards, along roadsides and railroad rights of way, and on turf such as lawns, golf courses and pastures. Nonagronomic uses of the present compositions also include invertebrate pest control in houses and other buildings which may be occupied by humans and/or companion, farm, ranch, zoo or other animals. Nonagronomic uses of the present compositions also include the control of pests such as termites that can damage wood or other structural materials used in buildings.

Nonagronomic uses of the present compositions also include protecting human and animal health by controlling invertebrate pests that are parasitic or transmit infectious diseases. The controlling of animal parasites includes controlling external parasites that are parasitic to the surface of the body of the host animal (e.g., shoulders, armpits, abdomen, inner part of the thighs) and internal parasites that are parasitic to the inside of the body of the host animal (e.g., stomach, intestine, lung, veins, under the skin, lymphatic tissue). External parasitic or disease transmitting pests include, for example, chiggers, ticks, lice, mosquitoes, flies, mites and fleas. Internal parasites include heartworms, hookworms and helminths. Compositions of the present disclosure are suitable for systemic and/or non-systemic control of infestation or infection by parasites on animals. Compositions of the present disclosure are particularly suitable for combating external parasitic or disease transmitting pests. Compositions of the present disclosure are suitable for combating parasites that infest agricultural working animals, such as cattle, sheep, goats, horses, pigs, donkeys, camels, buffalos, rabbits, hens, turkeys, ducks, geese and bees; pet animals and domestic animals such as dogs, cats, pet birds and aquarium fish; as well as so-called experimental animals, such as hamsters, guinea pigs, rats and mice. By combating these parasites, fatalities and performance reduction (in terms of meat, milk, wool, skins, eggs, honey, etc.) are reduced, so that applying a composition of the present disclosure allows more economic and simple husbandry of animals.

All plants or any part of a plant can be treated in accordance with the disclosure. The term “plants” as used herein is to be understood as all plants and plant populations such as, for example, desired and undesired wild plants or crop plants (including naturally occurring crop plants). Crop plants can be plants that can be obtained by conventional breeding and optimization methods or by biotechnological and genetic engineering methods or by combinations of these methods, including transgenic plants and including plant cultivars which can or cannot be protected by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits and seeds, as well as roots, tubers and rhizomes. The plant parts also include harvested material, and vegetative and generative propagation material, for example cuttings, tubers, rhizomes, offshoots and seeds.

Treatment of the plants and plant parts with the compositions according to the present disclosure is carried out by direct contact with the plant or plant part, or by action on the plant's environment, habitat or storage space using customary treatment methods. For example, treatment as described herein can be by dipping, spraying, evaporating, atomizing, broadcasting, spreading-on, injecting and, in the case of propagation material—particularly in the case of seeds—by applying a layer of a coating comprising the composition, optionally with additional layers.

In one embodiment, the compositions of the present disclosure are aerially delivered to plants. In another embodiment, the compositions of the present disclosure are delivered by an unmanned aerial vehicle (UAV).

Wild plant species and plant cultivars, or those obtained by conventional biological breeding methods, such as crossing or protoplast fusion, and parts thereof, may be treated. Also, transgenic plants and plant cultivars obtained by genetic engineering methods, if appropriate in combination with conventional methods (Genetically Modified Organisms), and parts thereof are treated. Plants of the plant cultivars that are in each case commercially available or in use are treated according to the disclosure. Plant cultivars are to be understood as meaning plants having novel properties (“traits”) which have been obtained by conventional breeding, by mutagenesis or by recombinant DNA techniques. These can be cultivars, biotypes or genotypes.

The transgenic plants or plant cultivars (obtained by genetic engineering) that may be treated according to the disclosure include all plants which, by the genetic modification, received genetic material which imparted particular advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products. Further and particularly emphasized examples of such traits are a better defense of the plants against animal and microbial pests, such as against insects, mites, phytopathogenic fungi, bacteria and/or viruses, and increased tolerance of the plants to certain herbicidally active compounds. Examples of transgenic plants include the important crop plants, such as cereals (wheat, rice), maize, soybeans, potatoes, sugar beet, tomatoes, peas and other vegetable varieties, cotton, tobacco, oilseed rape and fruit plants (with the fruits apples, pears, citrus fruits and grapes), and emphasis is given to maize, soybeans, potatoes, cotton, tobacco and oilseed rape. Traits include the increased defense of the plants against insects, arachnids, nematodes and slugs and snails by toxins formed in the plants, particularly those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb, CryIF, Vip3A, and also combinations thereof) (“Bt plants”). Other traits are the increased defense of plants against fungi, bacteria and viruses by systemic acquired resistance (SAR), systemin, phytoalexins, elicitors and resistance genes and correspondingly expressed proteins and toxins. Traits also include the increased tolerance of the plants to certain herbicidally active compounds, for example imidazolinones, sulfonylureas, glyphosate or phosphinotricin (for example the “PAT” gene). The genes which impart the desired traits in question can also be present in combinations with one another in the transgenic plants. Examples of “Bt plants” include maize varieties, cotton varieties, soybean varieties and potato varieties which are sold under the trade names YIELD GARD® (for example maize, cotton, soybeans), KnockOut® (for example maize), StarLink® (for example maize), Bollgard® (cotton), Nucotn® (cotton) and NewLeaf® (potato). Examples of herbicide-tolerant plants are maize varieties, cotton varieties and soybean varieties that are sold under the trade names Roundup Ready® (tolerance to glyphosate, for example maize, cotton, soybean). Liberty Link® (tolerance to phosphinotricin, for example oilseed rape), IMI® (tolerance to imidazolinones) and STS® (tolerance to sulfonylureas, for example maize). Herbicide-resistant plants (plants bred in a conventional manner for herbicide tolerance) include the varieties sold under the name Clearfield® (for example maize). The agricultural crops are selected from the group consisting of cereals, fruit trees, citrus fruits, legumes, horticultural crops, cucurbits, oleaginous plants, tobacco, coffee, tea, cocoa, sugar beet, sugar cane, and cotton.

Depending on the plant species or plant cultivars, their location and growth conditions (soils, climate, vegetation period, diet), the treatment according to the disclosure may also result in superadditive (“synergistic”) effects. Thus, for example, reduced application rates and/or a widening of the activity spectrum and/or an increase in the activity of the substances and compositions which can be used according to the disclosure, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

Crops that can be protected with the compositions according to this disclosure, for example, comprise cereals (wheat, barley, rye, oats, rice, maize, sorghum, etc.), fruit trees (apples, pears, plums, peaches, almonds, cherries, bananas, grapes, strawberries, raspberries, blackberries, etc.), citrus trees (oranges, lemons, mandarins, grapefruit, etc.), legumes (beans, peas, lentils, soybean, etc.), vegetables (spinach, lettuce, asparagus, cabbage, carrots, onions, tomatoes, potatoes, eggplants, peppers, etc.), cucurbitaceae (pumpkins, zucchini, cucumbers, melons, watermelons, etc.), oleaginous plants (sunflower, rape, peanut, castor, coconut, etc.), tobacco, coffee, tea, cocoa, sugar beet, sugar cane, and cotton.

To protect the agricultural crops, the compositions of this disclosure can be applied to any part of the plant, or on the seeds before sowing, or on the soil in which the plant grows.

With regards to FIG. 2, scouting data source 208 provides scouting data to PPP computing device 112 for use in generating pest pressure predictions. Scouting data may include any data provided by a human scout that monitors one or more geographic locations. For example, the scouting data may include crop condition, pest counts (e.g., manually counted at a pest trap by the human scout), etc. In some embodiments, scouting data source 208 is one of client systems 114. That is, a scout can both provide scouting data to PPP computing device 112 and view pest pressure prediction data and/or heat map data using the same computing device (e.g., a mobile computing device).

Grower data source 210 provides grower data to PPP computing device 112 for use in generating pest pressure predictions. Grower data may include, for example, field boundary data, crop condition data, etc. Further, similar to scouting data source 208, in some embodiments, grower data source 210 is one of client systems 115. That is, a grower can both provide scouting data to PPP computing device 112 and view pest pressure prediction data and/or heat map data using the same computing device (e.g., a mobile computing device).

Other data source 212 may provide other types of data to PPP computing device 112 that are not available from data sources 202-210. For example, in some embodiments, other data source 212 includes a mapping database that provides mapping data (e.g., topographical maps of one or more geographic locations) to PPP computing device 112.

In the example embodiment, PPP computing device 112 receives data from at least one of data sources 202-212, and aggregates and analyzes that data (e.g., using machine learning) to generate pest pressure prediction data, as described herein. Further, PPP computing device 112 may also aggregate and analyze that data to generate heat map data, as described herein. The pest pressure prediction data and/or heat map data may be transmitted to client system 114 (e.g., for displaying to a user of client system 114).

In some embodiments, data from at least one of data sources 202-210 is automatically pushed to PPP computing device 112 (e.g., without PPP computing device 112 polling or querying data sources 202-210). Further, in some embodiments, PPP computing device 112 polls or queries (e.g., periodically or continuously) at least one of data sources 202-210 to retrieve the associated data.

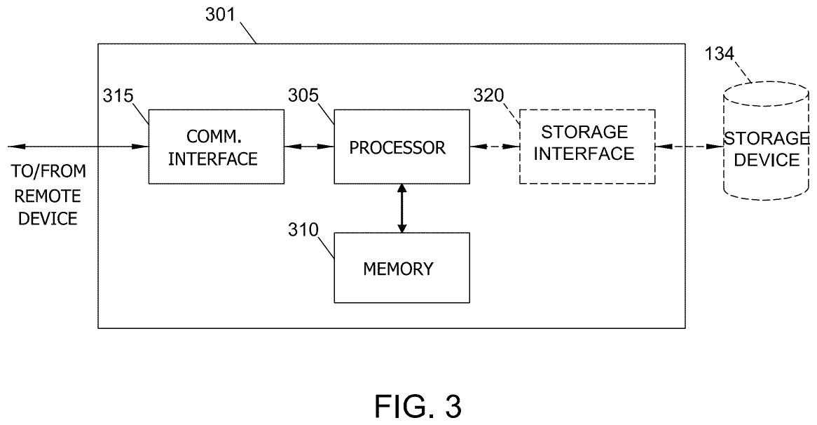

FIG. 3 illustrates an example configuration of a server system 301 such as PPP computing device 112 (shown in FIGS. 1 and 2), in accordance with one example embodiment of the present disclosure. Server system 301 may also include, but is not limited to, database server 116. In the example embodiment, server system 301 generates pest pressures prediction data and heat map data as described herein.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from a client system 114 via the Internet, as illustrated in FIG. 2.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

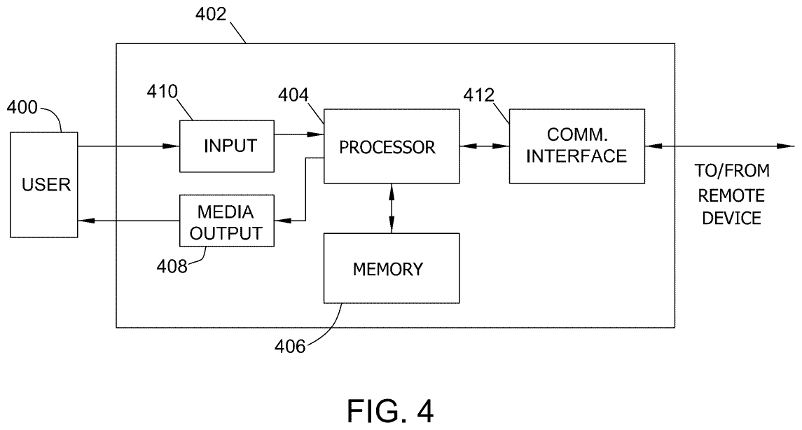

FIG. 4 illustrates an example configuration of a client computing device 402. Client computing device 402 may include, but is not limited to, client systems (“client computing devices”) 114. Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400. Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 301 or a web server. Communication interface 412 may include, for example, a wired or wireless network adapter or a wireless data transceiver for use with a mobile phone network (e.g., Global System for Mobile communications (GSM), 3G, 4G, 5G, or Bluetooth) or other mobile data network (e.g., Worldwide Interoperability for Microwave Access (WIMAX)).

Stored in memory area 406 are, for example, computer-readable instructions for providing a user interface to user 400 via media output component 408 and, optionally, receiving and processing input from input device 410. A user interface may include, among other possibilities, a web browser and client application. Web browsers enable users 400 to display and interact with media and other information typically embedded on a web page or a website from a web server. A client application allows users 400 to interact with a server application. The user interface, via one or both of a web browser and a client application, facilitates display of pest pressure information provided by PPP computing device 112. The client application may be capable of operating in both an online mode (in which the client application is in communication with PPP computing device 112) and an offline mode (in which the client application is not in communication with PPP computing device 112).

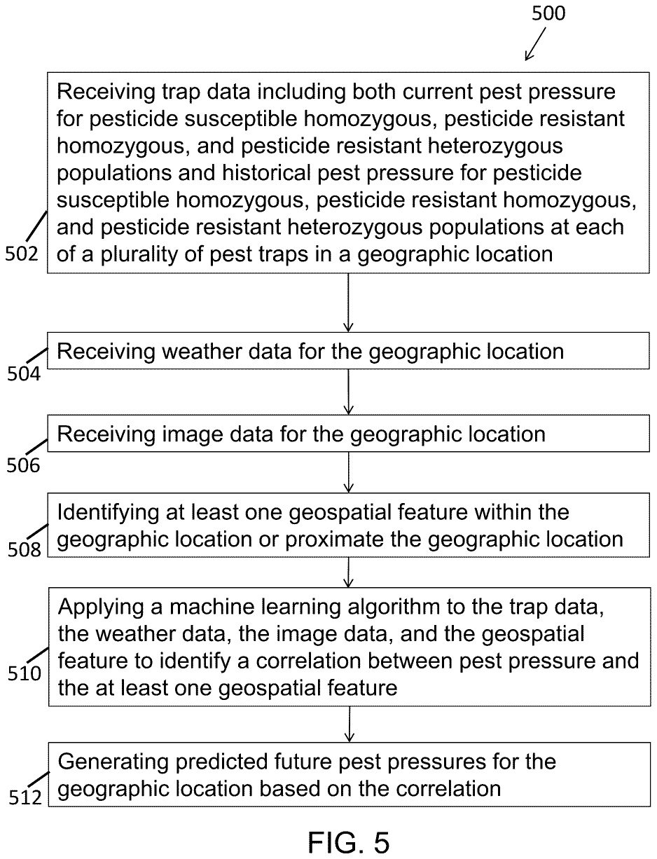

FIG. 5 is a flow diagram of an example method 500 for generating pest pressure data. Method 500 may be implemented, for example, using PPP computing device 112.

Method 500 includes receiving 502 trap data for a plurality of pest traps in a geographic location. In the example embodiment, the trap data includes both current pest pressure for pesticide susceptible homozygous, pesticide resistant homozygous, and pesticide resistant heterozygous populations and historical pest pressure for pesticide susceptible homozygous, pesticide resistant homozygous, and pesticide resistant heterozygous populations at each of the plurality of traps. The trap data may be received 502 from, for example, trap data source 206 (shown in FIG. 2). Further, PPP computing device 112 may analyze the received 502 trap data to generate additional data. For example, from the received 502 trap data, PPP computing device 112 may determine, for a number of different pest pressure levels for pesticide susceptible homozygous, pesticide resistant homozygous, and pesticide resistant heterozygous populations (e.g., defined by suitable upper and lower thresholds), the number of traps at each level. Further, PPP computing device 112 may determine average pest pressures across a number of traps and/or across at least a portion of the geographic location. This additional data may be used in identifying correlations and predicting future pest pressures, as described herein.

Method 500 further includes receiving 504 weather data 502 for the geographic location. In the example embodiment, the weather data includes both current and historical weather conditions for the geographic location. Further, in some embodiments, the weather data may include predicted future weather conditions for the geographic location. The weather data may be received 504 from, for example, weather data source 202 (shown in FIG. 2).

In the example embodiment, method 500 further includes receiving 506 image data for the geographic location. The image data may include, for example, satellite and/or drone image data. The image data may be received 506 from, for example, imaging data source 204 (shown in FIG. 2).

Further, method 500 includes identifying 508 at least one geospatial feature within the geographic location or proximate the geographic location.

As used herein, a ‘geospatial feature’ refers to a geographic feature or structure that may have an impact on pest pressure. For example, a geographic feature may include a body of water (e.g., a river, a stream, a lake, etc.), an elevation feature (e.g., a mountain, a hill, a canyon, etc.), a transportation route (e.g., a road, a railroad track, etc.), a farm location, or a factory (e.g., a cotton factory).

In one embodiment, the at least geospatial feature is identified 508 from existing map data. For example, PPP computing device 112 may retrieve previously generated maps (e.g., topographical maps, elevation maps, road maps, surveys, etc.) from a map data source (such as other data source 212 (shown in FIG. 2)), the previously generated maps demarcating the one or more geospatial features.

In another embodiment, PPP computing device 112 identifies 508 the one or more geospatial features by analyzing the received 506 image data. For example, PPP computing device 112 may apply raster processing to the image data to generate a digital elevation map, where each pixel (or other similar subdivision) of the digital elevation map is associated with an elevation value. Then, based on the elevation values, PPP computing device 112 identifies 508 the one or more geospatial features from the digital elevation map. For example, elevation features and/or bodies of water may be identified using such techniques.

Method 500 further includes applying 510 a machine learning algorithm to the trap data, the weather data, the image data, and the at least one identified geospatial feature to identify a correlation between pest pressure and the at least one geospatial feature. Applying 510 the machine learning algorithm to the trap data, the weather data, the image data, and the at least one identified geospatial feature may be seen as applying 510 a machine learning-based scheme to the trap data, the weather data, the image data, and the at least one identified geospatial feature to identify a correlation between pest pressure and the at least one geospatial feature. In one or more example embodiments, applying 510 the machine learning algorithm to the trap data, the weather data, the image data, and the at least one identified geospatial feature may include determining a pest pressure value associated with a pest trap, based on a relation (e.g. a correlation) between pest pressure and the at least one geospatial feature.

In some embodiments, PPP computing device 112 may determine, by applying 510 the machine learning algorithm, that pest pressure (e.g., at the location of a pest trap) for pesticide susceptible homozygous, pesticide resistant homozygous, and pesticide resistant heterozygous populations varies based on a distance from the at least one identified geospatial feature. For example, PPP computing device 112 may determine that pest pressure for pesticide susceptible homozygous, pesticide resistant homozygous, and pesticide resistant heterozygous populations is higher at locations proximate to a body of water (e.g., due to increased pest levels at the body of water). In another example, PPP computing device 112 may determine that pest pressure for pesticide susceptible homozygous, pesticide resistant homozygous, and pesticide resistant heterozygous populations is higher at locations proximate a transportation route (e.g., due to increased pest levels resulting from material transported along the transportation route). In yet another example, PPP computing device 112 may determine that pest pressure for pesticide susceptible homozygous, pesticide resistant homozygous, and pesticide resistant heterozygous populations is higher at locations proximate a factory (e.g., due to increased pest levels resulting from materials processed at the factory). In yet other examples, PPP computing device 112 may determine that pest pressure for pesticide susceptible homozygous, pesticide resistant homozygous, and pesticide resistant heterozygous populations is reduced at locations proximate the at least one identified geospatial feature. The at least one identified geospatial feature may be the area that has been treated by a pest control product.

Those of skill in the will appreciate that applying 510 the machine learning algorithm may identify other correlations between pest pressure for pesticide susceptible homozygous, pesticide resistant homozygous, and pesticide resistant heterozygous populations at the at least one geospatial feature. Specifically, the machine learning algorithm considers the trap data, the weather data, the image data, and the at least one identified geospatial feature in combination, and is capable of detecting complex interactions between those different types of data that may not be ascertainable by a human analyst. For example, non-distance-based correlations between the at least one identified geospatial feature and pest pressure may be identified in some embodiments.

For example, in one or more example embodiments, applying 510 the machine learning algorithm to the trap data, the weather data, the image data, and the at least one identified geospatial feature may include determining a pest pressure value associated with a pest trap for pesticide susceptible homozygous, pesticide resistant homozygous, and pesticide resistant heterozygous populations, based on a model (e.g. a machine learning model, a pest lifecycle model) characterizing a relation (e.g. a correlation) between pest pressure and the trap data (optionally wherein the trap data includes insect data, and/or developmental stage data of the insect). Further, in one or more example embodiments, applying 510 the machine learning algorithm to the trap data, the weather data, the image data, and the at least one identified geospatial feature may include determining a pest pressure value associated with a pest trap for pesticide susceptible homozygous, pesticide resistant homozygous, and pesticide resistant heterozygous populations, based on a model (e.g. a machine learning model) characterizing a relation (e.g. a correlation) between pest pressure, the trap data, and the weather data.

Further, in some embodiments, pest pressure for pesticide susceptible homozygous, pesticide resistant homozygous, and pesticide resistant heterozygous populations for a first pest may be correlated to pest pressure for a second, different pest, and that correlation may be detected using PPP computing device 112. For example, the at least one geospatial feature is a particular field having a known high pest pressure for the second pest. Using the systems and methods described herein, PPP computing device 112 may determine that locations proximate the particular field generally have a high pest pressure for the first pest, which correlates to the pest pressure level of the second pest in the particular field. These “inter-pest” correlations may be complex relationships that are identifiable by PPP computing device 112, but that would not be identifiable by a human analyst. Similarly, “inter-crop” correlations may be identified by PPP computing device 112 between nearby geographic locations that product different crops.

Subsequently, method 500 includes generating 512 predicted future pest pressures for pesticide susceptible homozygous, pesticide resistant homozygous, and pesticide resistant heterozygous populations for the geographic location based on at least the identified correlation. Specifically, PPP computing device 112 uses the identified correlation, in combination with one or more models, algorithms, etc. to predict future pest pressure values for the geographic location. For example, PPP computing device 112 may utilize spray timer models, pest lifecycle models, etc. in combination with the identified correlation, trap data, weather data, and image data to generate 512 predicted future pest pressures based on identified patterns. Those of skill in the art will appreciate that other types of data may also be incorporated to generated 512 predicted future pest pressures. For example, previously planted crop data, neighboring farm data, field water level data, and/or soil type data may be considered when predicting future pest pressures.

As one example of a model, developmental stages of a pest of interest (e.g., an insect, or a fungus) may be governed by an ambient temperature. Accordingly, using a “degree day” model, developmental stages of the pest may be predicted based on heat accumulation (e.g., determined from temperature data).

The generated 512 predicted future pest pressures for pesticide susceptible homozygous, pesticide resistant homozygous, and pesticide resistant heterozygous populations are one example of pest pressure prediction data that may be transmitted to and displayed on a user computing device, such as client system 114 (shown in FIGS. 1 and 2). For example, the predicted future pest pressures for pesticide susceptible homozygous, pesticide resistant homozygous, and pesticide resistant heterozygous populations may be transmitted to the user computing device to cause the user computing device to present the predicted future pest pressures in a textual, graphical, and/or audio format, or any other suitable format. As described below in detail, in some embodiments, one or more heat maps illustrating predicted future pest pressures for pesticide susceptible homozygous, pesticide resistant homozygous, and pesticide resistant heterozygous populations are displayed on the user computing device.

From the generated 512 predicted future pest pressures for pesticide susceptible homozygous, pesticide resistant homozygous, and pesticide resistant heterozygous populations, in some embodiments, the systems and methods described herein may also be used to generate (e.g., using machine learning) a treatment recommendation for the geographic location to address the predicted future pest pressures. For example, with an accurate prediction of future pest pressures for pesticide susceptible homozygous, pesticide resistant homozygous, and pesticide resistant heterozygous populations in place, PPP computing device 112 may automatically generate a treatment plan for the geographic location to mitigate future levels of high pest pressure. The treatment plan may specify, for example, one or more substances (e.g., pesticides, fertilizers, etc.) and specific times when those one or more substances should be applied (e.g., daily, weekly etc.). Alternatively, the treatment plan may include other data to facilitate improving agricultural performance in view of predicted future pest pressures.

Further, in some embodiments, the generated 512 predicted future pest pressures for pesticide susceptible homozygous, pesticide resistant homozygous, and pesticide resistant heterozygous populations are used (e.g., by PPP computing device 112) to control additional systems. In one embodiment, a system for monitoring pest pressure (e.g., a system including pest traps) may be controlled based on the predicted future pest pressures. For example, a reporting frequency and/or type of trap data reported by one or more pest traps may be modified based on the predicted future pest pressures. In another example, spraying equipment (e.g., for spraying pesticides) or other agricultural equipment may be controlled based on the predicted future pest pressures.

As noted above, PPP computing device 112 may also generate one or more heat maps using pest pressure prediction data. For the purposes of this discussion, PPP computing device 112 may be referred to herein as heat map generation computing device 112.

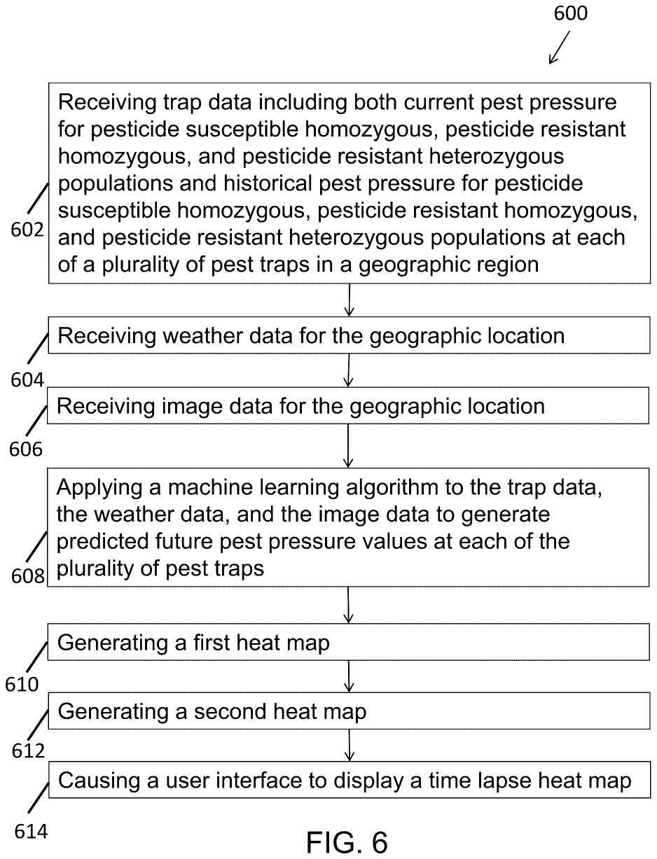

FIG. 6 is a flow diagram of an example method 600 for generating heat maps for pesticide susceptible homozygous, pesticide resistant homozygous, and pesticide resistant heterozygous populations. Method 600 may be implemented, for example, using heat map generation computing device 112 (shown in FIG. 1).

Method 600 includes receiving 602 trap data for a plurality of pest traps in a geographic region. In the example embodiment, the trap data includes both current pest pressure for pesticide susceptible homozygous, pesticide resistant homozygous, and pesticide resistant heterozygous populations and historical pest pressure for pesticide susceptible homozygous, pesticide resistant homozygous, and pesticide resistant heterozygous populations at each of the plurality of traps. The trap data may be received 602 from, for example, trap data source 206 (shown in FIG. 2).

Further, method 600 includes receiving 604 weather data for the geographic location. In the example embodiment, the weather data includes both current and historical weather conditions for the geographic location. Further, in some embodiments, the weather data may include predicted future weather conditions for the geographic location. The weather data may be received 604 from, for example, weather data source 202 (shown in FIG. 2).

In the example embodiment, method 600 further includes receiving 606 image data for the geographic location. The image data may include, for example, satellite and/or drone image data. The image data may be received 606 from, for example, imaging data source 204 (shown in FIG. 2).

Method 600 further includes applying 608 a machine learning algorithm to the trap data, the weather data, and the image data to generate predicted future pest pressure values for pesticide susceptible homozygous, pesticide resistant homozygous, and pesticide resistant heterozygous populations at each of the plurality of pest traps.

In addition, method 600 includes generating 610 a first heat map for pesticide susceptible homozygous, pesticide resistant homozygous, and pesticide resistant heterozygous populations and generating 612 a second heat map for pesticide susceptible homozygous, pesticide resistant homozygous, and pesticide resistant heterozygous populations. In the example embodiment, the first heat map is associated with a first point in time and the second heat map is associated with a difference, second point in time. The first and second heat maps may be generated 610, 612 as follows.

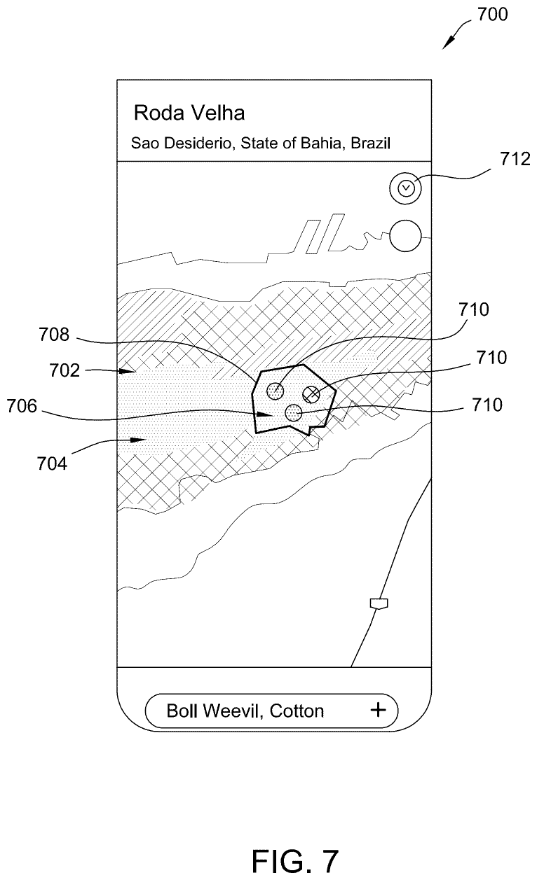

In the example embodiment, each heat map is generated by plotting a plurality of nodes on a map of the geographic location. Each node corresponds to the location of particular pest trap of the plurality of pest traps. Further, in the example embodiment, each node is displayed in a color that represents the pest pressure value for pesticide susceptible homozygous, pesticide resistant homozygous, and pesticide resistant heterozygous populations for the corresponding test trap at the associated point in time. In one example, each node is displayed green (indicating a low pest pressure value), yellow (indicating a moderate pest pressure value), or red (indicating a high pest pressure value). In FIGS. 7-9, green is indicated by a diagonal line pattern, yellow is indicated by a cross hatch pattern, and red is indicated by a dot pattern. Those of skill in the art will appreciate that other numbers of colors and different colors may be used in the embodiments described herein. Depending on the point in time associated with the heat map, the color of the node may indicate a past pest pressure value for pesticide susceptible homozygous, pesticide resistant homozygous, and pesticide resistant heterozygous populations (if the point in time is in the past), a current pest pressure value for pesticide susceptible homozygous, pesticide resistant homozygous, and pesticide resistant heterozygous populations (if the point in time is the present), or a predicted future pest pressure value for pesticide susceptible homozygous, pesticide resistant homozygous, and pesticide resistant heterozygous populations (if the point in time is in the future). The future predicted pest pressure values for pesticide susceptible homozygous, pesticide resistant homozygous, and pesticide resistant heterozygous populations may be generated, for example, using machine learning algorithms, as described herein.

To complete the heat map for pesticide susceptible homozygous, pesticide resistant homozygous, and pesticide resistant heterozygous populations, at least some of the remaining portions of the map including the colored nodes are colored. Specifically, remaining portions of the map are colored to generate a continuous map of pest pressure values for pesticide susceptible homozygous, pesticide resistant homozygous, and pesticide resistant heterozygous populations. In the example embodiment, the remaining portions are colored by interpolating between the pest pressure values at the plurality of nodes.

In one embodiment, interpolation is performed using an inverse distance weighting (IDW) algorithm, wherein points on remaining portions of the map are colored based on their distance from known pest pressure values for pesticide susceptible homozygous, pesticide resistant homozygous, and pesticide resistant heterozygous populations at the nodes. For example, in such an embodiment, pest pressure values for pesticide susceptible homozygous, pesticide resistant homozygous, and pesticide resistant heterozygous populations for locations without nodes may be calculated based on a weighted average of inverse distances nearby nodes. This embodiment operates under the assumption that pest pressure for pesticide susceptible homozygous, pesticide resistant homozygous, and pesticide resistant heterozygous populations at a particular point will be more strongly influenced by nodes that are closer (as opposed to more distant nodes). In other embodiments, interpolation may be performed based on other criteria in addition to, or alternative to distance from the nodes.

With pest pressure values for pesticide susceptible homozygous, pesticide resistant homozygous, and pesticide resistant heterozygous populations generated for at least some of the remaining portions of the map (using interpolation, as described above), those portions are colored based on the generated pest pressure values for pesticide susceptible homozygous, pesticide resistant homozygous, and pesticide resistant heterozygous populations. As with the nodes, in one example, green indicates a low pest pressure value for pesticide susceptible homozygous, pesticide resistant homozygous, and pesticide resistant heterozygous populations, yellow indicates a moderate pest pressure value for pesticide susceptible homozygous, pesticide resistant homozygous, and pesticide resistant heterozygous populations, and red indicates a high pest pressure value for pesticide susceptible homozygous, pesticide resistant homozygous, and pesticide resistant heterozygous populations. Pest pressures may be similarly colored for pesticide susceptible and pesticide resistant populations.

The thresholds for the different colors may be set, for example, based on historical pest pressure, and may be adjusted over time (automatically or based on user input). Those of skill in the art will appreciate that these three colors are only examples, and that any suitable coloring scheme may be used to generate the heat maps described herein.

In the example embodiment, the first and second heat maps for pesticide susceptible homozygous, pesticide resistant homozygous, and pesticide resistant heterozygous populations are stored in a database, such as database 120 (shown in FIG. 1). Accordingly, in this embodiment, when a user views heat maps on a user device (e.g., a mobile computing device), as described below, the heat maps have already been previously generated and stored by heat map generation computing device 112. Alternatively, heat maps may be generated and displayed in real-time based on the user's request.

With the first and second heat maps generated 610, 612, in the example embodiment, method 600 further includes causing 614 a user interface to display a time lapse heat map. The user interface may be, for example, a user interface displayed on client device 114 (shown in FIGS. 1 and 2). The user interface may be implemented, for example, via an application installed on the client device 114 (e.g., an application provided by the entity that operates heat generation computing device 112).

The time lapse heat map displays an animation on the user interface. Specifically, in the example embodiment, the time lapse heat map dynamically transitions between a plurality of previously generated heat maps (e.g., the first and second heat maps) over time, as described below. Accordingly, by viewing the dynamic heat map, users can easily see and appreciate changes in pest pressure over time for the geographic region. The time lapse heat map may display past, current, and/or future pest pressure values for pesticide susceptible homozygous, pesticide resistant homozygous, and pesticide resistant heterozygous populations for the geographic region.

It should be understood that, in example embodiment, the second heat map for pesticide susceptible homozygous, pesticide resistant homozygous, and pesticide resistant heterozygous populations for a second point in time is generated using predicted pest pressure values for pesticide susceptible homozygous, pesticide resistant homozygous, and pesticide resistant heterozygous populations, and this second point in time refers to a point in time later than the time of the most recent current and historical pest pressure values for pesticide susceptible homozygous, pesticide resistant homozygous, and pesticide resistant heterozygous populations (e.g., included in the trap data) incorporated into the machine learning algorithm. That is, the second point in time refers to a future point in time in such embodiments.

With respect to the first heat map for a first point in time, in the example embodiment, this is generated using pest pressure values for pesticide susceptible homozygous, pesticide resistant homozygous, and pesticide resistant heterozygous populations for a point in time earlier than the second point in time. Accordingly, the pest pressure values used for generating the first heat map for pesticide susceptible homozygous, pesticide resistant homozygous, and pesticide resistant heterozygous populations are generally either current or historical pest pressure values for pesticide susceptible homozygous, pesticide resistant homozygous, and pesticide resistant heterozygous populations. In another embodiment, the first point in time is also a future point in time, but a different point in time than the second point in time. Thus, the pest pressure values used for generating the first heat map for pesticide susceptible homozygous, pesticide resistant homozygous, and pesticide resistant heterozygous populations are predicted pest pressure values as well.

Within the scope of this disclosure, it should be understood that reference made herein to “a first heat map” and “a second heat map” and to “the first and second heat maps” can imply that one or more (e.g., a plurality of) “intermediate heat maps” are generated using pest pressure values for pesticide susceptible homozygous, pesticide resistant homozygous, and pesticide resistant heterozygous populations (e.g. current, historical or predicted pest pressure values, as the case may be) for various points in time between the first point in time and the second point in time. In such cases, the time lapse heat map displays a dynamic transition between the first heat map, the one or more intermediate heat maps, and the second heat map over time. In one embodiment, the intermediate heat maps include one or more (e.g., a plurality of) intermediate heat maps generated using predicted pest pressure values. In another embodiment, the intermediate heat maps include one or more (e.g., a plurality of) intermediate heat maps generated using current and/or historical pest pressure values. In yet another embodiment, the intermediate heat maps include one or more (e.g., a plurality of) intermediate heat maps generated using predicted pest pressure values and one or more (e.g., a plurality of) intermediate heat maps generated using current and/or historical pest pressure values.

In one embodiment, to display the time lapse heat map, each previously generated heat map is displayed for a brief period of time before instantaneously transitioning to the next heat map (e.g., in a slideshow format). Alternatively, in some embodiments, heat map generation computing device 112 temporally interpolates between consecutive heat maps to generate transition data (e.g., using machine learning) between those heat maps. In such embodiments, the time lapse heat map displays a smooth evolution of pest pressure over time, instead of a series of static images.

FIG. 7 is a first screenshot 700 of a user interface that may be displayed on a computing device, such as client system 114 (shown in FIGS. 1 and 2). The computing device may be, for example, a mobile computing device.

First screenshot 700 includes a pest pressure heat map 702 that displays pest pressure associated with a particular pest and crop in a region 704 including a field 706. In the example shown in first screenshot 700, the pest is boll weevil and the crop is cotton. Those of skill in the art will appreciate that the heat maps described herein may display pest pressure information for any suitable pest and crop. Further, in some embodiments, heat maps may display pest pressures for multiple pests in the same crop, one pest in multiple crops, or multiple pests in multiple crops.

As shown in FIG. 7, field 706 is demarcated on heat map 702 by a field boundary 708. Field boundary 708 may be plotted on heat map 702 by heat map generation computing device 112 based on, for example, information provided by a grower associated with field 706. For example, the grower may provide information to heat map generation computing device 112 from a grower computing device, such as grower data source 210 (shown in FIG. 2).

Heat map 702 includes three nodes 710, corresponding to three pest traps in field 706. As shown in FIG. 7, each node 710 has an associated color (here two red nodes and one yellow node). Further, in heat map 702, locations not including nodes 710 are colored by interpolating the pest pressure values for pesticide susceptible homozygous, pesticide resistant homozygous, and pesticide resistant heterozygous populations at nodes 710, generating a continuous map of pest pressure values for pesticide susceptible homozygous, pesticide resistant homozygous, and pesticide resistant heterozygous populations. Although only three nodes 710 are shown in FIG. 7, those of skill in the art will appreciate that the additional pest traps may be used to color portions of heat map 702. Nodes 710 may be subdivided for pesticide susceptible homozygous, pesticide resistant homozygous, and pesticide resistant heterozygous populations, and colored separately for first and second heat maps 702. In this example, heat map 702 is a static heat map that shows pest pressure for pesticide susceptible homozygous, pesticide resistant homozygous, and pesticide resistant heterozygous populations at a particular point in time (e.g., one of the first and second heat maps described above).

First screenshot 700 further includes a time lapse button 712 that, when selected by a user, causes a time lapse heat map to be displayed, as described herein.

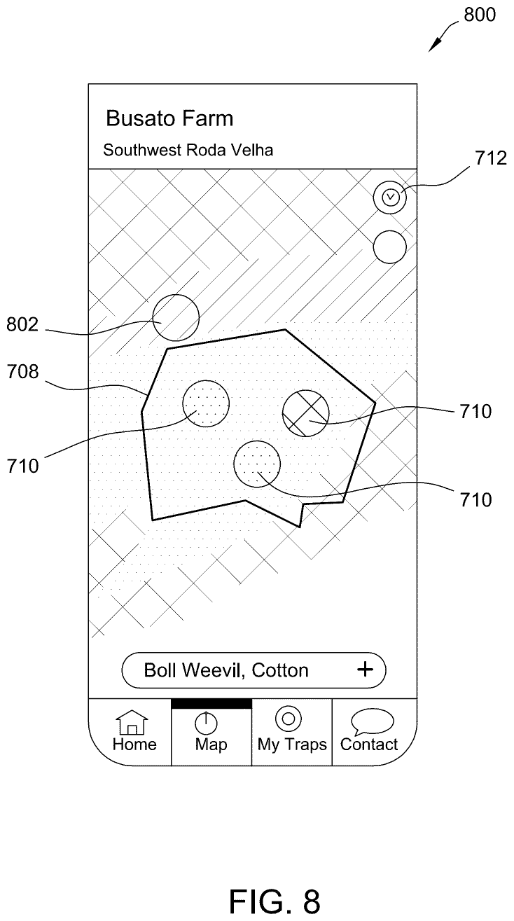

FIG. 8 is a second screenshot 800 of the user interface that may be displayed on a computing device, such as client system 114 (shown in FIGS. 1 and 2). Specifically, second screenshot 800 shows an enlarged view of heat map 702 for pesticide susceptible homozygous, pesticide resistant homozygous, and pesticide resistant heterozygous populations. The enlarged view may be generated, for example, in response to the user making a selection on the user interface to change a zoom level.

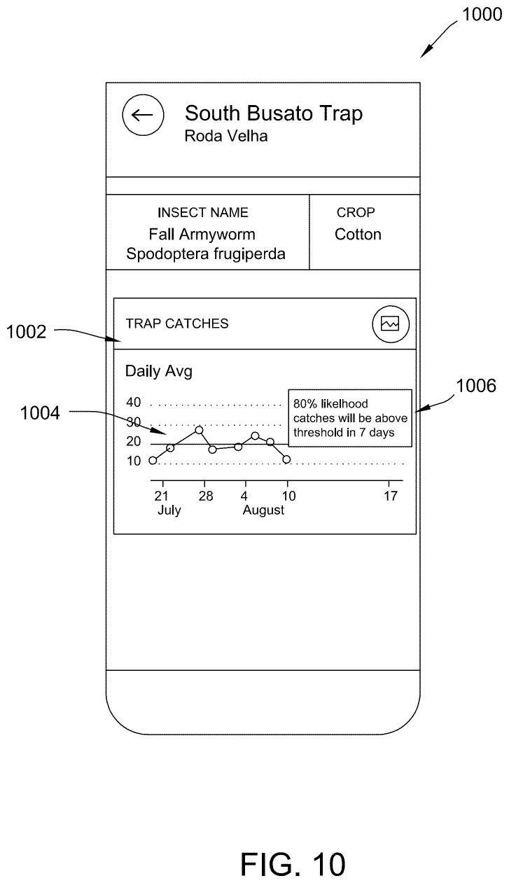

As shown in FIG. 8, additional information not shown in first screenshot 700 is shown in the enlarged view. For example, an additional node 802 (representing an additional trap) is now visible. Further, an associated trap name is displayed with each node 710. In the exemplary embodiment, in the enlarged view, the user can select a particular node 710 to cause the user interface to display pest pressure data for pesticide susceptible homozygous, pesticide resistant homozygous, and pesticide resistant heterozygous populations for that node 710. This is described in further detail below in association with FIG. 10.

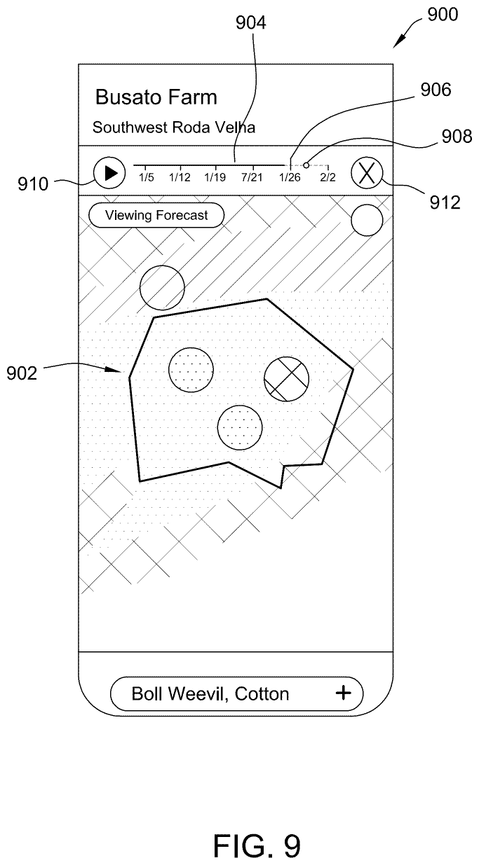

FIG. 9 is a third screenshot 900 of the user interface that may be displayed on a computing device, such as client system 114 (shown in FIGS. 1 and 2). Specifically, third screenshot 900 shows a time lapse heat map 902 for pesticide susceptible homozygous, pesticide resistant homozygous, and pesticide resistant heterozygous populations. Time lapse heat map 902 may be displayed, for example, in response to the user selecting time lapse button 712 (shown in FIGS. 7 and 8).

As shown in FIG. 9, a timeline 904 is displayed in association with time lapse heat map 902 for pesticide susceptible homozygous, pesticide resistant homozygous, and pesticide resistant heterozygous populations. Timeline 904 enables a user to quickly determine which time pest pressure for pesticide susceptible homozygous, pesticide resistant homozygous, and pesticide resistant heterozygous populations is currently being shown for. Timeline 904 shows a range of dates, including historical and future dates in the example embodiment. Further, timeline 904 includes a current time marker 906 indicating the current (i.e., present time), as well as a selected time marker 908 that indicates what time is associated with the pest pressure for pesticide susceptible homozygous, pesticide resistant homozygous, and pesticide resistant heterozygous populations shown on time lapse heat map 902.

For example, in FIG. 9, timeline 904 extends from January 5 to February 2, the current day is January 26, and time lapse heat map 902 shows pest pressures for January 29. Notably, the pest pressure shown in FIG. 9 is a predicted future pest pressure, as selected time marker 908 is later than current time marker 906.

In one embodiment, a user can adjust selected time marker 908 (e.g., by selecting and dragging selected time marker 908) to manipulate what time is displayed by time lapse heat map 902. Further, in the example embodiment, when the user selects an activation icon 910, time lapse heat map 902 is displayed as an animation, automatically transitioning between different static heat maps to show the evolution of pest pressure over time. A stop icon 912 is also shown in screenshot 900. When the user has previously selected activation icon 910, the user can select the stop icon 912 to stop the animation and freeze time lapse heat map 902 at a desired point in time.

FIG. 10 is a fourth screenshot 1000 of the user interface that may be displayed on a computing device, such as client system 114 (shown in FIGS. 1 and 2). Specifically, fourth screenshot 1000 shows pest pressure data 1002 for a particular trap for pesticide susceptible homozygous, pesticide resistant homozygous, and pesticide resistant heterozygous populations. Pest pressure data 1002 may be displayed, for example, in response to the user selecting a particular node 710 (as described above in reference to FIG. 8). In one embodiment, pest pressure data 1002 includes graphical data 1004 that displays pest pressure over time (e.g., current and historical pest pressure) and textual data 1006 that summarizes predicted future pest pressure.

Further, in some embodiments, the generated heat maps facilitate controlling additional systems. In one embodiment, a system for monitoring pest pressure (e.g., a system including pest traps) may be controlled based on the heat maps. For example, a reporting frequency and/or type of trap data reported by one or more pest traps may be modified based on the heat maps. In another example, spraying equipment (e.g., for spraying pesticides) or other agricultural equipment may be controlled based on the heat maps.

At least one of the technical problems addressed by this system includes: i) inability to accurately monitor pest pressure; ii) inability to accurately predict future pest pressure; and iii) inability to communicate pest pressure information to a user in a comprehensive, straightforward manner.

The technical effects provided by the embodiments described herein include at least i) monitoring pest pressure in real-time; ii) accurately predicting future pest pressure using machine learning; iii) controlling other systems or equipment based on predicted future pest pressures; iv) generating comprehensive heat maps illustrating pest pressure; v) generating time lapse heat maps that dynamically display changes in pest pressure over time; and vi) controlling other systems or equipment based on generated heat maps.

Further, a technical effect of the systems and processes described herein is achieved by performing at least one of the following steps: (i) receiving trap data for a plurality of pest traps in a geographic location, the trap data including pest genetic data, the trap data including current and historical pest pressure values at each of the plurality of pest traps; (ii) receiving weather data for the geographic location; (iii) receiving image data for the geographic location; (iv) applying a machine learning algorithm to the trap data, the weather data, and the image data to generate predicted future pest pressure values at each of the plurality of pest traps; (v) generating a first heat map for a first point in time and a second heat map for a second point in time, the second heat map generated using the predicted future pest pressure values, the first and second heat maps each generated by a) plotting a plurality of nodes on a map of the geographic location, each node corresponding to one of the plurality of pest traps, each node having a color that represents the pest pressure value for the corresponding pest trap at the associated point in time, and b) coloring at least some remaining portions of the map of the geographic location to generate a continuous map of pest pressure values for the geographic location by interpolating between pest pressure values associated with the plurality of nodes at the associated point in time; and (vi) transmitting the first and second heat maps to a mobile computing device to cause a user interface on the mobile computing device to display a time lapse heat map that dynamically transitions between the first heat map and the second heat map over time, the user interface implemented via an application installed on the mobile computing device.

A processor or a processing element in the embodiments described herein may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to analyzing trap data, weather data, image data, geospatial (e.g., using one or more models) to predict future pest pressure.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

### EXAMPLES

Without further elaboration, it is believed that one skilled in the art using the preceding description can utilize the present disclosure to its fullest extent. The following Examples are, therefore, to be construed as merely illustrative, and not limiting of the disclosure in any way whatsoever.

In the following examples, FAM is 6-carboxyfluorescein, MGBQ is a minor groove binding nonfluorescent quencher, HEX is hexachlorofluorescein, VIC is an asymmetrical xanthene dye, and BHQ1 is Black Hole Quencher 1.

### Example 1. qPCR Assay

A qPCR assay was performed using Taqman probes of I4790M SNP in the ryanodine receptor gene in fall armyworm (FAW) (P. xylostella RyR numbering). The oligomers used are as-follows.

| | | | 5′ | 3′ |
|---|---|---|---|---|
| Oligomer | Sequence (5′-3′) | SEQ ID NO. | Probe | Probe |
| Forward | ACGACGATGCACTAGAAG | SEQ ID NO: 1 | N/A | N/A |
| | OR | OR | | |
| | CGACGATGCACTAGAAGTG | SEQ ID NO: 2 | | |
| Reverse | ACCTTGAGATGGTAGTACC | SEQ ID NO: 3 | N/A | N/A |
| Probe 14790M | CTCGCTATGCTCATCGGGT | SEQ ID NO: 4 | FAM | MGBQ |
| Probe | TGTCGCTCGCTATACTCATCG | SEQ ID NO: 5 | HEX | MGBQ |
| susceptible- | | | | |
| allele | | | | |

The PCR setup was as-follows. PCR was performed under common thermocycler and end-point fluorescence measurement conditions on a 7500 qPCR machine. Initial denaturation was at 95° C. for 5 minutes. Then 35 cycles were performed for 95° C. for 15 seconds and then 60° C. for 30 seconds. Endpoint analysis was performed.

| | | | Final | |
|---|---|---|---|---|
| Component | Single Reaction | | Concentration | |
| qPCR Master Mix 2X | 10 | μL | 1X | |
| Forward primer, 10 μM | 0.8 | μL | 0.4 | μM |
| Reverse primer, 10 μM | 0.8 | μL | 0.4 | μM |
| Probe for susceptible | 0.4 | μL | 0.2 | μM |
| allele (WT), 10 μM | | | | |
| Probe for resistant allele | 0.4 | μL | 0.2 | μM |
| (14790M), 10 μM | | | | |
| Template (5-20 ng | 2.0 | μL | ≤1 | ng/μL |

| | | |
|---|---|---|
| genomic DNA) | | |
| DEPC-treated water | To 20 μL final volume | — |

The expected result is shown in FIG. 11. In FIG. 11, blue represents the homozygous and resistant RR genotype, green represents the heterozygous RS genotype, and red represents the homozygous and susceptible SS genotype.

### Example 2. qPCR Assay

A qPCR assay was performed using Taqman probes of G4903E SNP in the Tuta ryanodine receptor gene (G4946E according to P. xylostella RyR numbering). The oligomers used are as-follows.

| | | | 5′ | 3′ |
|---|---|---|---|---|
| Oligomer | Sequence (5′-3′) | SEQ ID NO. | Probe | Probe |
| Forward | AACAACTTCTTCTTCGCG | SEQ ID NO: 6 | N/A | N/A |
| Reverse | TGTGACAGACTGCAAGATG | SEQ ID NO: 7 | N/A | N/A |
| Probe | CGCTGTTGAGTTTAAGACGT | SEQ ID NO: 8 | FAM | MGBQ |
| susceptible- | | | | |
| allele | | | | |
| Probe | GATGTCGCTGTTGGGTTTAAG | SEQ ID NO: 9 | VIC | MGBQ |
| resistant-allele | | | | |

The PCR setup was as-follows. PCR was performed under common thermocycler and end-point fluorescence measurement conditions on a 7500 qPCR machine. Initial denaturation was at 95° C. for 5 minutes. Then 35 cycles were performed for 95° C. for 15 seconds and then 58-60° C. for 20 seconds. Endpoint analysis was performed.

| | | | Final | |
|---|---|---|---|---|
| Component | Single Reaction | | Concentration | |
| qPCR Master Mix 2X | 10 | μL | 1X | |
| Forward primer, 10 μM | 0.8 | μL | 0.4 | μM |
| Reverse primer, 10 μM | 0.8 | μL | 0.4 | μM |
| Probe for susceptible | 0.4 | μL | 0.2 | μM |
| allele, 10 μM | | | | |
| Probe for resistant allele, | 0.4 | μL | 0.2 | μM |
| 10 μM | | | | |
| Template (5-20 ng | 2.0 | μL | ≤1 | ng/μL |

genomic DNA)

| | | |
|---|---|---|
| DEPC-treated water | To 20 μL final volume | — |

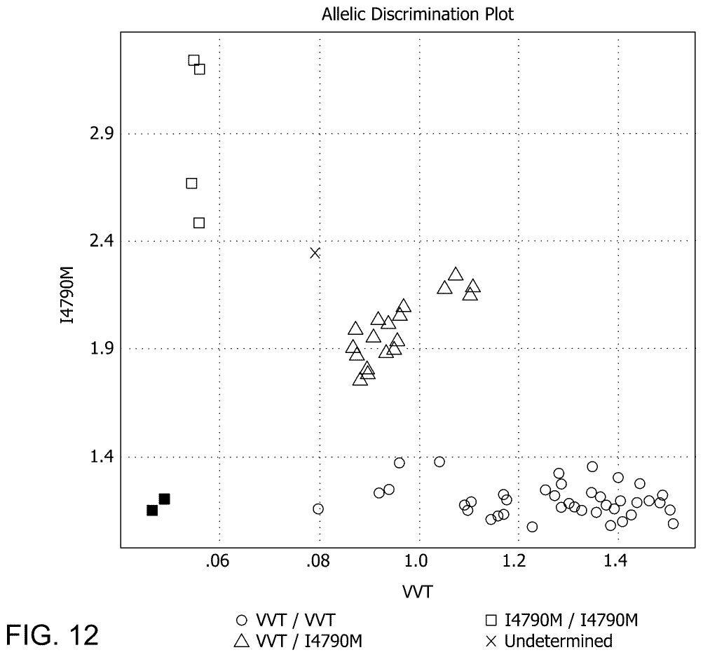

The expected result is shown in FIG. 12. In FIG. 12, blue represents the homozygous and resistant RR genotype, green represents the heterozygous RS genotype, and red represents the homozygous and susceptible SS genotype.

### Example 3. Molecular Monitoring of I4790M in FAW

A qPCR method based on Taqman® probes, such as the methods of Examples 1 and 2, can be used on a large scale for allelic discrimination. In the context of pesticidal resistance, genotyping of single individuals allows determination of resistant, heterozygous, or susceptible genotypes. Such genotyping can be performed quickly, with turnover on the order of one day or less.

The allele frequency of I4790M in the F1 generation of fall armyworm (FAW) was monitored on crops according to the method of the present disclosure. The results are shown in the table below.

| | | SS | RS | RR | R Allele |
|---|---|---|---|---|---|
| | | Frequency | Frequency | Frequency | Frequency |
| Location | n | (%) | (%) | (%) | (%)* |
| 1 | 29 | 59 | 28 | 14 | 27.6 |
| 2 | 30 | 77 | 20 | 3 | 13.3 |
| 3 | 30 | 27 | 43 | 30 | 51.7 |
| 4 | 20 | 100 | 0 | 0 | 0 |
| 5 | 29 | 100 | 0 | 0 | 0 |
| 6 | 30 | 73 | 20 | 7 | 16.7 |
| 7 | 30 | 87 | 13 | 0 | 6.7 |
| 8 | 30 | 77 | 23 | 0 | 11.7 |
| 9 | 30 | 50 | 30 | 20 | 35.0 |
| 10 | 30 | 87 | 10 | 3 | 8.3 |
| 11 | 28 | 100 | 0 | 0 | 0 |
| 12 | 30 | 100 | 0 | 0 | 0 |
| 13 | 28 | 100 | 0 | 0 | 0 |
| 14 | 30 | 97 | 3 | 0 | 1.7 |
| 15 | 28 | 100 | 0 | 0 | 0 |
| 16 | 27 | 81 | 19 | 0 | 9.3 |
| 17 | 29 | 86 | 14 | 0 | 6.9 |
| 18 | 28 | 100 | 0 | 0 | 0 |

*0% means that R allele frequency was below the detection level, which is 1.7% based on method sensitivity

Extremely high R allele frequencies (>20%) were observed in several locations. Very high R allele frequencies (11-20%) and high R allele frequencies (5-10%) were also observed. In all the locations with high R allele frequencies to extremely high R allele frequencies, the heterozygous RS frequency was at least 10%, which is the main carrier of the R allele.

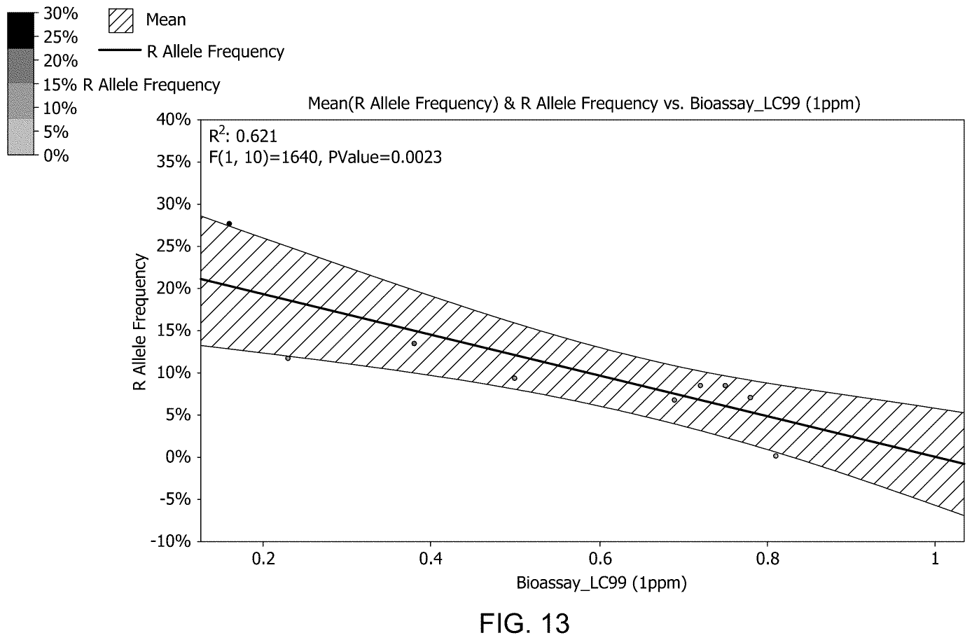

The R allele frequency vs bioassay at LC99 was measured for these populations. As shown in FIG. 13, for 12 out of 18 FAW populations, some correlation between R allele frequency and bioassay data was observed (R2=0.62; p=0023). SNP conferring 14790M seems to be widely spread throughout corn production areas. The correlation between R allele frequency and bioassay data was accurate for about 70% of FAW field populations, which suggests that bioassay is critical to identify another R mechanism.

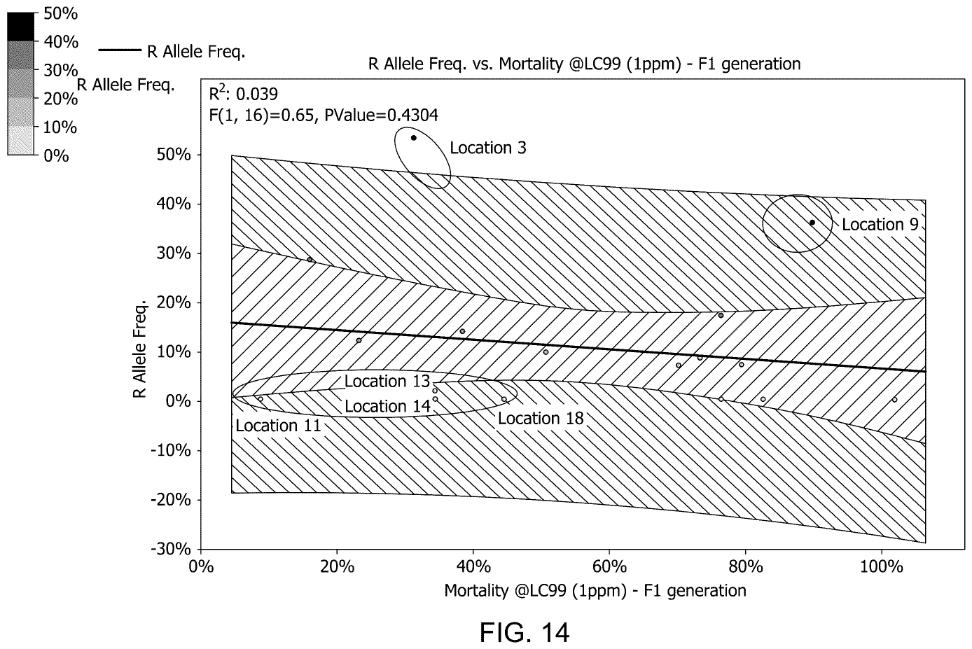

The R allele frequency vs mortality at LC99 was measured for these populations. As shown in FIG. 14, the red circle indicates a non-direct correlation, the blue circle indicates a potential fitness cost, and the green circle indicates that there may be other single nucleotide polymorphisms (SNPs) or other resistance mechanisms involved.

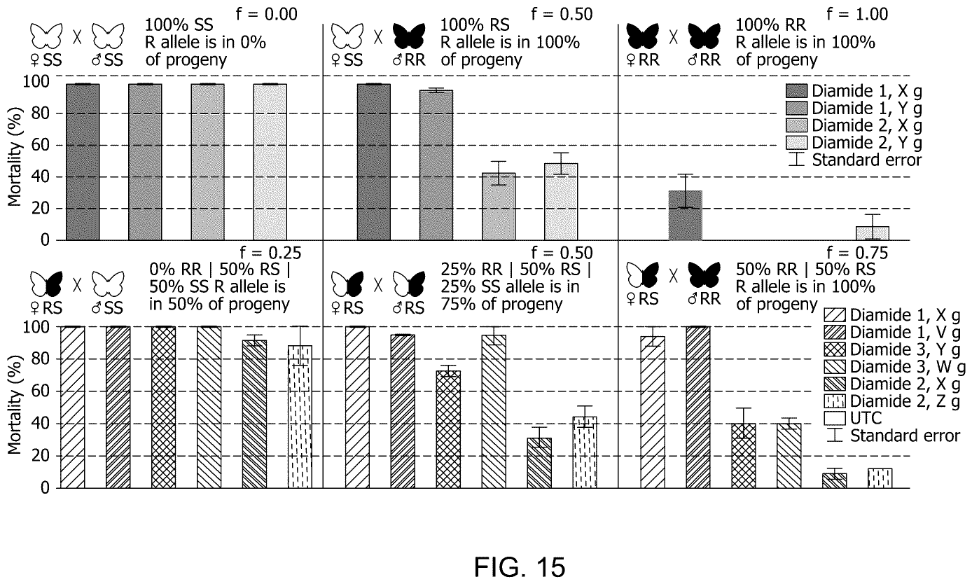

The mortality at LC99 was determined for various diamide pesticides for these populations. As shown in FIG. 15, different allele frequencies experience higher mortality for certain diamides. The SS homozygotes exhibited the highest relative mortalities, while the RR homozygotes exhibited the lowest relative mortalities.

### Example 4. Insecticidal Resistance Management (IRM) Recommendations

The methods according to the present disclosure may include provide a recommendation for managing insecticidal resistance.

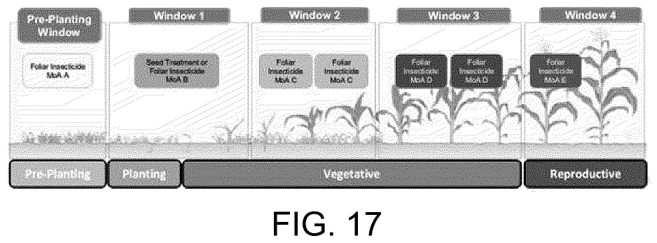

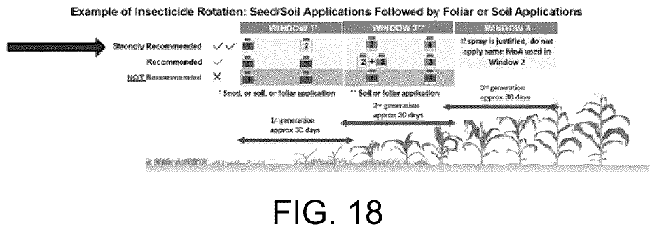

One such recommendation includes treating successive generations of FAW with products have different modes of action (MoA). Another such recommendation includes treating FAW in a treatment window approach and rotating MoA in each window if needed. FIGS. 17-18 each depict an illustrative treatment window recommendation.

### Example 5. qPCR Assay

A qPCR assay was performed using Taqman probes of G4903E SNP in Tuta absoluta (G4946E according to P. xylostella RyR numbering). The oligomers used are as-follows.

| | | | 5′ | 3′ |
|---|---|---|---|---|
| Oligomer | Sequence (5′-3′) | SEQ ID NO. | Probe | Probe |
| Forward | AACAACTTCTTCTTCGCG | SEQ ID NO: 10 | N/A | N/A |
| Reverse | TTATGTGTGACAGACTGCAA | SEQ ID NO: 11 | N/A | N/A |
| Probe | GATGTCGCTGTTGGGTTTAAG | SEQ ID NO: 12 | FAM | BHQ1 |
| susceptible- | | | | |
| allele | | | | |
| Probe G4903E | CGCTGTTGAGTTTAAGACGT | SEQ ID NO: 13 | HEX | BHQ1 |

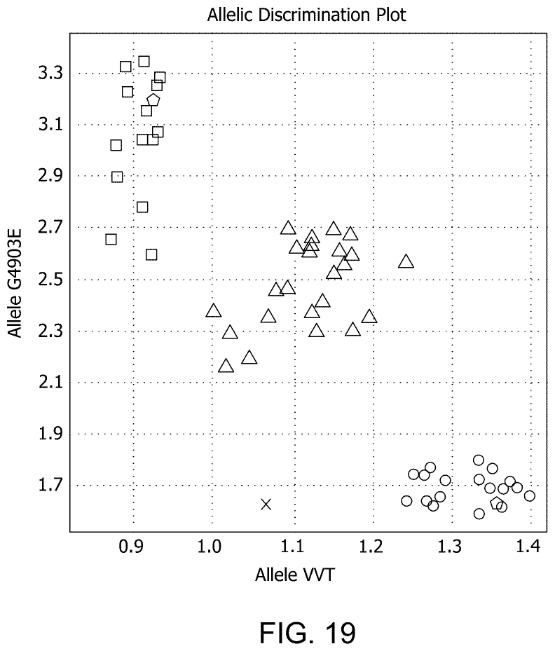

The result is shown in FIG. 19. In FIG. 19, blue represents the homozygous and resistant RR genotype, green represents the heterozygous RS genotype, light blue represents controls from each genotype, red represents the homozygous and susceptible SS genotype, and X represents undetermined genotype.

### Example 6. qPCR Assay

A qPCR assay was performed using Taqman probes of I4790M SNP in Spodoptera frugiperda (P. xylostella RyR numbering). The oligomers used are as-follows.

| | | | 5′ | 3′ |
|---|---|---|---|---|
| Oligomer | Sequence (5′-3′) | SEQ ID NO. | Probe | Probe |
| Forward | GACGATGCACTAGAAGTG | SEQ ID NO: 14 | N/A | N/A |
| Reverse | ACCTTGAGATGGTAGTACC | SEQ ID NO: 15 | N/A | N/A |
| Probe 14790M | TGCTCGCTAAACTCATCGGGT | SEQ ID NO: 16 | FAM | BHQ1 |
| Probe | TGTCGCTCGCTATACTCATCG | SEQ ID NO: 17 | HEX | BHQ1 |
| susceptible- | | | | |
| allele | | | | |

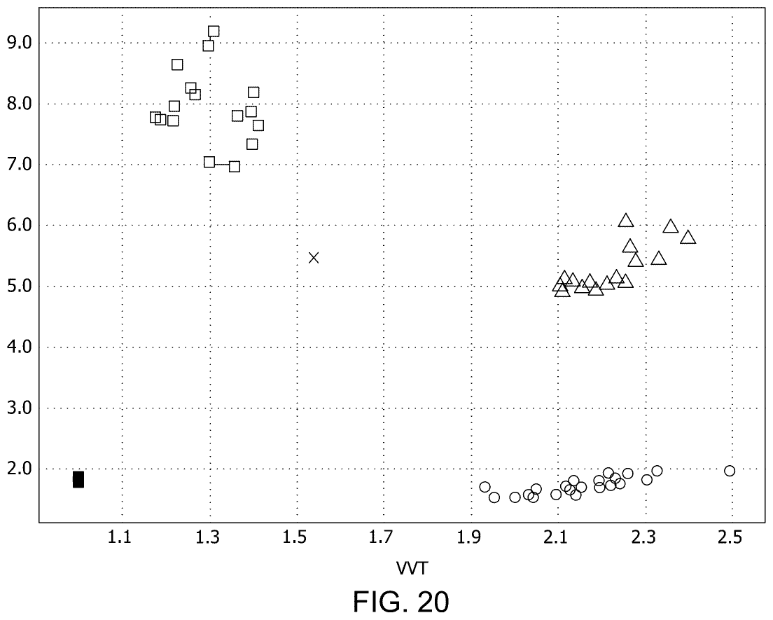

The result is shown in FIG. 20. In FIG. 20, blue represents the homozygous and resistant RR genotype, green represents the heterozygous RS genotype, red represents the homozygous and susceptible genotype, and X represents undetermined genotype.

### Example 7. qPCR Assay

A qPCR assay was performed using Taqman probes of I4790K SNP in Spodoptera frugiperda (P. xylostella RyR numbering). The oligomers used are as-follows.

| | | | 5′ | 3′ |
|---|---|---|---|---|
| Oligomer | Sequence (5′-3′) | SEQ ID NO. | Probe | Probe |
| Forward | GACGATGCACTAGAAGTG | SEQ ID NO: 18 | N/A | N/A |
| Reverse | ACCTTGAGATGGTAGTACC | SEQ ID NO: 19 | N/A | N/A |
| Probe 14790K | CTCGCTATGCTCATCGGGT | SEQ ID NO: 20 | FAM | MGBQ |
| Probe | TGTCGCTCGCTATACTCATCG | SEQ ID NO: 21 | HEX | MGBQ |
| susceptible- | | | | |
| allele | | | | |

The result is shown in FIG. 20. In FIG. 20, blue represents the homozygous and resistant RR genotype, green represents the heterozygous RS genotype, red represents the homozygous and susceptible SS genotype, and X represents undetermined genotype.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

It also is understood that any numerical range recited herein includes all values from the lower value to the upper value. For example, if a weight ratio range is stated as 1:50, it is intended that values such as 2:40, 10:30, or 1:3, etc., are expressly enumerated in this specification. These are only examples of what is specifically intended, and all possible combinations of numerical values between and including the lowest value and the highest value enumerated are to be considered to be expressly stated in this application.

As used herein, the term “about” means plus or minus 10% of the value.

What is claimed is:

1. A heat map generation computing device comprising:
a memory; and
a processor communicatively coupled to the memory, the processor programmed to:
receive trap data for a plurality of pest traps in a geographic location, the trap data including pest genetic data, the trap data including current and historical pest pressure values at each of the plurality of pest traps;
receive at least one of i) weather data for the geographic location and ii) image data for the geographic location;
apply a machine learning algorithm to the trap data and the at least one of the weather data and the image data to generate predicted future pest pressure values for pesticide susceptible and pesticide resistant populations at each of the plurality of pest traps;
generate a first heat map for a first point in time for pesticide susceptible and pesticide resistant populations and a second heat map for a second point in time for pesticide susceptible and pesticide resistant populations, the second heat map generated using the predicted future pest pressure values, the first and second heat maps each generated by:
plotting a plurality of nodes on a map of the geographic location, each node corresponding to one of the plurality of pest traps, each node indicating the pest pressure value for the corresponding pest trap at the associated point in time for pesticide susceptible and pesticide resistant populations; and
annotating at least some remaining portions of the map of the geographic location to generate a continuous map of pest pressure values for the geographic location by interpolating between pest pressure values associated with the plurality of nodes at the associated point in time for pesticide susceptible and pesticide resistant populations; and
transmit the first and second heat maps to a mobile computing device to cause a user interface on the mobile computing device to display a time lapse heat map that dynamically transitions between the first heat map and the second heat map over time, the user interface implemented via an application installed on the mobile computing device.

2. The heat map generation computing device of claim 1, wherein at least one of the first point in time and the second point in time is a future point in time.

3. The heat map generation computing device of claim 1, wherein the processor is further programmed to:
generate a treatment recommendation for the geographic location based on the predicted future pest pressure values.

4. The heat map generation computing device of claim 1, wherein the processor is further programmed to:
receive, from the mobile computing device, a user selection of a selected node in the heat map, the user selection made using the user interface; and
cause the user interface to display, in response to the received user selection, pest pressure values for the selected node plotted over time.

5. The heat map generation computing device of claim 1, wherein the processor is programmed to annotate at least some remaining portions of the map by interpolating based on distances from near by pest traps of the plurality of pest traps.

6. The heat map generation computing device of claim 1, wherein to generate the first and second heat maps, the processor is further programmed to plot a farm boundary on the map of the geographic location.

7. The heat map generation computing device of claim 1, wherein the first and second heat maps are associated with a first pest, and wherein the processor is further programmed to:
generate a third heat map associated with a second pest;
receive a user selection of the second pest made using the user interface; and
cause the user interface to display, in response to the received user selection, the third heat map.

8. The heat map generation computing device of claim 1, wherein the pest genetic data are used to characterize relative proportions of pest genetic populations and to generate a treatment recommendation, wherein the pest genetic populations preferably include individuals selected from pesticide susceptible homozygous, pesticide resistant homozygous, and pesticide resistant heterozygous individuals.

9. The heat map generation computing device of claim 1, wherein genetic population dynamics are integrated with pest genetic data to generate a treatment recommendation.

10. A method for generating heat maps, the method implemented using a heat map generation computing device including a memory communicatively coupled to a processor, the method comprising:
receiving trap data for a plurality of pest traps in a geographic location, the trap data including pest genetic data, the trap data including current and historical pest pressure values at each of the plurality of pest traps;
receiving at least one of i) weather data for the geographic location and ii) image data for the geographic location;
applying a machine learning algorithm to the trap data and the at least one of the weather data and the image data to generate predicted future pest pressure values at each of the plurality of pest traps;
generating a first heat map for a first point in time and a second heat map for a second point in time, the second heat map generated using the predicted future pest pressure values, the first and second heat maps each generated by:
plotting a plurality of nodes on a map of the geographic location, each node corresponding to one of the plurality of pest traps, each node indicating the pest pressure value for the corresponding pest trap at the associated point in time; and
annotating at least some remaining portions of the map of the geographic location to generate a continuous map of pest pressure values for the geographic location by interpolating between pest pressure values associated with the plurality of nodes at the associated point in time; and
transmitting the first and second heat maps to a mobile computing device to cause a user interface on the mobile computing device to display a time lapse heat map that dynamically transitions between the first heat map and the second heat map over time, the user interface implemented via an application installed on the mobile computing device.

11. The method of claim 10, wherein at least one of the first point in time and the second point in time is a future point in time.

12. The method of claim 10, further comprising:
generating a treatment recommendation for the geographic location based on the predicted future pest pressure values.

13. The method of claim 10, further comprising:
receiving, from the mobile computing device, a user selection of a selected node in the heat map, the user selection made using the user interface; and
causing the user interface to display, in response to the received user selection, pest pressure values for the selected node plotted over time.

14. The method of claim 10, wherein annotating at least some remaining portions of the map comprises annotating by interpolating based on distances from nearby pest traps of the plurality of pest traps.

15. The method of claim 10, wherein generating the first and second heat maps further comprises plotting a farm boundary on the map of the geographic location.

16. The method of claim 10, wherein the first and second heat maps are associated with a first pest, and wherein the method further comprises:
generating a third heat map associated with a second pest;
receiving a user selection of the second pest made using the user interface; and
causing the user interface to display, in response to the received user selection, the third heat map.

17. The method of claim 10, further comprising using the pest genetic data to characterize relative proportions of pest genetic populations and to generate a treatment recommendation, wherein the pest genetic populations preferably include individuals selected from susceptible homozygous, resistant homozygous, and heterozygous individuals.

18. The method of claim 10, further comprising integrating genetic population dynamics with pest genetic data to generate a treatment recommendation.

19. A computer-readable storage medium having computer-executable instructions embodied thereon, wherein when executed by a heat map generation computing device including at least one processor in communication with a memory, the computer-readable instructions cause the heat map generation computing device to:
receive trap data for a plurality of pest traps in a geographic location, the trap data including pest genetic data, the trap data including current and historical pest pressure values at each of the plurality of pest traps;
receive at least one of i) weather data for the geographic location and ii) image data for the geographic location;
apply a machine learning algorithm to the trap data and the at least one of the weather data and the image data to generate predicted future pest pressure values at each of the plurality of pest traps;
generate a first heat map for a first point in time and a second heat map for a second point in time, the second heat map generated using the predicted future pest pressure values, the first and second heat maps each generated by:
plotting a plurality of nodes on a map of the geographic location, each node corresponding to one of the plurality of pest traps, each node indicating the pest pressure value for the corresponding pest trap at the associated point in time; and
annotating at least some remaining portions of the map of the geographic location to generate a continuous map of pest pressure values for the geographic location by interpolating between pest pressure values associated with the plurality of nodes at the associated point in time; and
transmit the first and second heat maps to a mobile computing device to cause a user interface on the mobile computing device to display a time lapse heat map that dynamically transitions between the first heat map and the second heat map over time, the user interface implemented via an application installed on the mobile computing device.

20. The computer-readable storage medium of claim 19, wherein at least one of the first point in time and the second point in time is a future point in time.

21. The computer-readable storage medium of claim 19, wherein the instructions further cause the heat map generation computing device to:
generate a treatment recommendation for the geographic location based on the predicted future pest pressure values.

22. The computer-readable storage medium of claim 19, wherein the instructions further cause the heat map generation computing device to:
receive, from the mobile computing device, a user selection of a selected node in the heat map, the user selection made using the user interface; and
cause the user interface to display, in response to the received user selection, pest pressure values for the selected node plotted over time.

23. The computer-readable storage medium of claim 19, wherein to annotate at least some remaining portions of the map, the instructions cause the heat map generation computing device to interpolate based on distances from nearby pest traps of the plurality of pest traps.

24. The computer-readable storage medium of claim 19, wherein to generate the first and second heat maps, the instructions cause the heat map generation computing device to plot a farm boundary on the map of the geographic location.

25. The computer-readable storage medium of claim 19, wherein the instructions cause the heat map generation computing device to use the pest genetic data to characterize relative proportions of pest genetic populations and to generate a treatment recommendation, wherein the pest genetic populations preferably include individuals selected from susceptible homozygous, resistant homozygous, and heterozygous individuals.

26. The computer-readable storage medium of claim 19, wherein the instructions cause the heat map generation computing device to integrate genetic population dynamics with pest genetic data to generate a treatment recommendation.
